(19) United States
(12) Patent Application Publication
(10) Pub. No.: US 2025/0331006 A1
(43) Pub. Date: Oct. 23, 2025

(54) SIDELINK SLOT STRUCTURE

(71) Applicant: FRAUNHOFER-GESELLSCHAFT ZUR FOERDERUNG DER ANGEWANDTEN FORSCHUNG E.V., Muenchen (DE)

(72) Inventors: Thomas FEHRENBACH, Berlin (DE); Sarun SELVANESAN, Berlin (DE); Baris GOEKTEPE, Berlin (DE); Thomas WIRTH, Berlin (DE); Thomas SCHIERL, Berlin (DE); Cornelius HELLGE, Berlin (DE)

(21) Appl. No.: 19/197,115

(22) Filed: May 2, 2025

Related U.S. Application Data
(63) Continuation of application No. PCT/EP2023/080697, filed on Nov. 3, 2023.

(30) Foreign Application Priority Data
Nov. 4, 2022 (EP) 22205632.7

(51) Int. Cl. H04W 72/40; H04W 72/0446; H04W 92/18

(52) U.S. Cl. CPC H04W 72/40; H04W 72/0446; H04W 92/18

(57) ABSTRACT

A user device, UE, for a wireless communication network, like a 3rd Generation Partnership Project, 3GPP, network, is described. The UE is to communicate with one or more further UEs in the wireless communication network over a sidelink, SL. The UE is configured or preconfigured with a time slot structure allowing a transmission to be started at one of a plurality of starting symbols during a duration of a time slot, the plurality of starting symbols including a first starting symbol and a second starting symbol, the first starting symbol being an automatic gain control, AGC, symbol and the second starting symbol being an AGC symbol and being offset from the first starting symbol. The UE is to start a transmission at the first starting symbol or at the second starting symbol. When the UE starts the transmission at the first starting symbol, the UE is to include into the time slot an additional AGC symbol, the additional AGC symbol being at a symbol of the time slot corresponding the second starting symbol.

### CROSS-REFERENCES TO RELATED APPLICATIONS

This application is a continuation of copending International Application No. PCT/EP2023/080697, filed Nov. 3, 2023, which is incorporated herein by reference in its entirety, and additionally claims priority from European Application No. EP 22 205 632.7, filed Nov. 4, 2022, which is incorporated herein by reference in its entirety.

The present invention concerns the field of wireless communication systems or networks, more specifically, a direct communication between user devices over a sidelink, e.g., a communication using resources in the licensed spectrum or in the unlicensed spectrum, also referred to as SL or SL-U. Embodiments concern the use of one or more additional automatic gain control signal, AGC, symbols in a time slot which allows a transmission by a user device to be started at one of two or more staring symbols.

### BACKGROUND OF THE INVENTION

FIGS. 1A and B are a schematic representation of an example of a terrestrial wireless network 100 including, as is shown in FIG. 1A, the core network 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1st-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 3GPPs NR, New Radio, or within LTE-U, LTE Unlicensed or NR-U, New Radio Unlicensed, which is specified within the LTE and within NR specifications.

The wireless network or communication system depicted in FIGS. 1A and B may be a heterogeneous network having distinct overlaid networks, e.g., a network of macro cells with each macro cell including a macro base station, like base station gNB₁ to gNB₅, and a network of small cell base stations, not shown in FIGS. 1A and B, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIGS. 1A and B, for example in accordance with the LTE-Advanced Pro or 5G or 5G-Advanced or NR, New Radio.

In mobile communication networks, for example in a network like that described above with reference to FIGS. 1A and B, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIGS. 1A and B. This is referred to as an “in-coverage” scenario. Another scenario is referred to as an “out-of-coverage” scenario. It is noted that “out-of-coverage” does not mean that the two UEs are necessarily outside one of the cells depicted in FIGS. 1A and B, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

FIG. 2A is a schematic representation of an in-coverage scenario in which two UEs directly communicating with each other are both connected to a base station. The base station gNB has a coverage area that is schematically represented by the circle 200 which, basically, corresponds to the cell schematically represented in FIGS. 1A and B. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X. Thus, in Mode 1, a SL UE, e.g., UE 202 is connected via Uu interface to the gNB, and the gNB coordinates the resources for UE 202 be used to transmit control and/or data to another UE, e.g., UE 204, via a SL interface, which is referred to in NR as PC5.

FIG. 2B is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2B which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2A, in addition to the NR mode 1 or LTE mode 3 UEs 202, 204 also NR mode 2 or LTE mode 4 UEs 206, 208, 210 are present. In addition, FIG. 2B, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210. Thus, the SL UEs, e.g., UEs 206-210, need not to have a connectivity to the gNB, and perform a sensing & access resource allocation or a random access-based resource allocation, e.g., when transmitting from UE 206 to UE 208. Nevertheless, basic configurations need to be available for the UEs 206-210, in order to successfully exchange data. This information may be pre-configured or may be configured while a UE is within coverage of the gNB. For this the gNB may provide a basic configuration, e.g., basic information, which may be transported via a broadcast channel, e.g., using system information blocks (SIBs). The BS may also assist Mode 2 UEs to provide basic information on which resource pool (RP) is to be used or may act as a synchronization source.

Although FIG. 2A and FIG. 2B illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of the sidelink in a wireless communication system or network.

### SUMMARY

An embodiment may have a user device, UE, for a wireless communication network, like a 3^{rd} Generation Partnership Project, 3GPP, network, wherein the UE is to communicate with one or more further UEs in the wireless communication network over a sidelink, SL, wherein the UE is configured or preconfigured with a time slot structure allowing a transmission to be started at one of a plurality of starting symbols during a duration of a time slot, the plurality of starting symbols including a first starting symbol and a second starting symbol, the second starting symbol being offset from the first starting symbol, wherein the UE is to start a transmission at the first starting symbol or at the second starting symbol, and wherein, when the UE starts the transmission at the first starting symbol, the UE is to include into the time slot an additional symbol, the additional symbol being ahead of or at a symbol of the time slot corresponding the second starting symbol.

Another embodiment may have a user device, UE, for a wireless communication network, wherein the UE is to communicate with one or more further UEs of the wireless communication network, wherein the UE is to receive a transmission from a transmitting UE during a time slot, wherein the transmission of the transmitting UE starts at a first starting symbol during a duration of a time slot, wherein the UE is to transmit a transmission during the time slot, wherein the transmission of the UE starts at a second starting symbol during a duration of a time slot, the second starting symbol being an AGC symbol and being offset from the first starting symbol, wherein the transmission includes an additional symbol ahead of or at a symbol of the time slot corresponding to the second starting symbol.

Another embodiment may have a method for operating a user device, UE, for a wireless communication network, wherein the UE communicates with one or more further UEs in the wireless communication network over a sidelink, SL, the method comprising: configuring or preconfiguring the UE with a time slot structure allowing a transmission to be started at one of a plurality of starting symbols during a duration of a time slot, the plurality of starting symbols including a first starting symbol and a second starting symbol, the second starting symbol being an AGC symbol and being offset from the first starting symbol, starting, by the UE, a transmission at the first starting symbol or at the second starting symbol, and when the UE starts the transmission at the first starting symbol, including, by the UE, into the time slot an additional symbol, the additional symbol being ahead of or at a symbol of the time slot corresponding the second starting symbol.

### BRIEF DESCRIPTION OF THE DRAWINGS

Embodiments of the present invention will be detailed subsequently referring to the appended drawings, in which:

FIGS. 1A and B are a schematic representation of an example of a terrestrial wireless network;

FIG. 2A is a schematic representation of an in-coverage scenario;

FIG. 2B is a schematic representation of an out-of-coverage scenario;

FIGS. 3A and B illustrate two examples for sidelink time slot formats, wherein FIG. 3A illustrates a time slot format having one guard symbol, and FIG. 3B illustrates time slot format having two guard symbols;

FIG. 4 illustrates multiple time slots with transmissions aligned in the frequency domain;

FIG. 5 illustrates a scenario of a sidelink UE starting two transmissions in adjacent channels or frequency bands at the only starting symbol of the time slot structure of FIG. 3A;

FIG. 6 illustrates a scenario of a sidelink UE starting two transmissions in adjacent channels or frequency bands at the different starting symbols provided in the time slot structure of FIG. 3A;

FIG. 7 is a schematic representation of a wireless communication system including a transmitter, like a base station, and one or more receivers, like user devices, UEs, implementing embodiments of the present invention;

FIG. 8 illustrates a wireless communication system including user devices and a base station in accordance with embodiments of the present invention;

FIGS. 9A and B illustrate an embodiment of the present invention including in a full-slot transmission an additional AGC symbol;

FIG. 10 illustrates an embodiment of the present invention starting a transmission at a second starting position of a slot and extending into a following slot having a time slot structure according to FIG. 3A;

FIG. 11 illustrates an embodiment similar to FIG. 10 except that the time slot structure in the following slot has a time slot structure including an additional AGC symbol;

FIGS. 12A, B, C and D illustrate embodiments of the present invention in which respective transmissions in the two frequency bands are such that the DMRS-symbols are aligned,

FIG. 13 illustrates an embodiment of the present invention using a time slot structure according to FIG. 3B with an additional AGC symbol located ahead of PSFCH symbols; and

FIG. 14 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

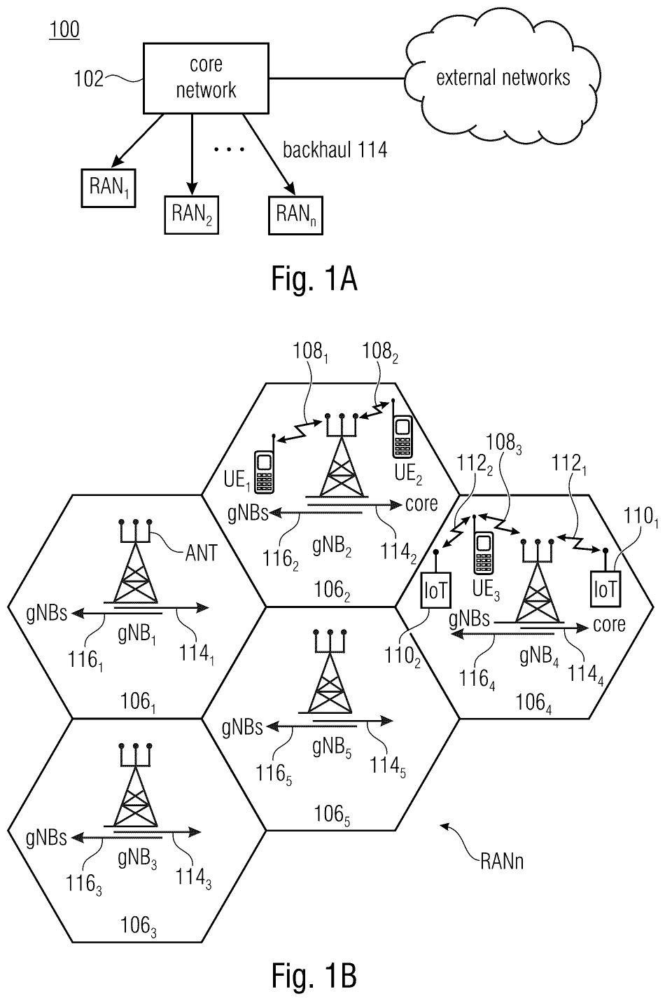

In mobile communication systems or networks, like those described above with reference to FIGS. 1A and B, for example in an LTE or 5G/NR network, the respective entities may communicate using one or more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier or subcarrier, a bandwidth part, BWP, a subband, a subchannel, an interlace, a resource block set, RB-set, and the like.

When using a single frequency band, the communication may be referred to as a single-band operation, e.g., a UE transmits/receives radio signals to/from another network entity on frequencies being within the band, like the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum. Also mixed combinations are possible, e.g., one or more frequency bands in licensed and one or more frequency bands in unlicensed bands. Furthermore, CA may also be just used for aggregation of an additional carrier in one direction, e.g., as a supplemental carrier to improve transmissions via UL, DL or SL.

5G New Radio (NR) may support an operation in the unlicensed spectrum so that a single-band operation or a multi-band operation may include frequency bands or subbands in the unlicensed spectrum. The unlicensed spectrum may include bands with a potential IEEE 802.11 coexistence, such as frequency bands within the 5 GHz and/or the 6 GHz spectrum. NR-U may support bandwidths that are an integer multiple of 20 MHZ, for example due to regulatory requirements. The splitting into the subbands may be performed so as to minimize interference with coexisting systems, like IEE 802.11 systems, which may operate in one or more of the same bands with the same nominal bandwidth channels, like 20 MHz channels. Other examples, of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands, Listen-before-talk, LBT, may be performed separately per subband or per resource block set (RB set). This may lead to a situation in which one or more of the subbands are busy or occupied due to an interference, for example, from other communication systems coexisting on the same band, like other public land mobile networks, PLMNs or systems operating in accordance with the IEEE 802.11 specification or operating under the ETSI Broadband Radio Access Networks, BRAN, specifications. In such a situation, the transmitter, either the transmitting gNB or the transmitting UE, is only allowed to transmit on the subbands which are detected to be not busy, also referred to as subbands being free or non-occupied. For example, for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy, or non-won subbands.

For accessing resources or channels in the unlicensed spectrum, a so-called NR-U channel access is to be performed, which makes use of a channel access procedure, which is a procedure based on sensing that evaluates the availability of a channel for performing transmissions. The basic unit for sensing may be a sensing slot with a certain duration, e.g., Tₛₗ=9 μs. The sensing slot duration Tₛₗ is considered to be idle if a base station or a UE senses the channel during the sensing slot duration and determines that the detected power is less than an energy detection threshold for at least a certain time, like 4 μs. within the sensing slot duration. Otherwise, the sensing slot duration is considered to be busy. In case a channel is available or not busy, one or more transmission may be performed on the channel, and the so-called channel occupancy refers to the one or more transmissions on the one or more channels by the base station or UE after performing the corresponding channel access procedure. A channel occupancy time, COT, refers to the total time for which the base station or UE and any other base station or UE may share the channel occupancy to perform one or more transmissions on the channel after the base station or UE has performed the channel access procedure, CAP.

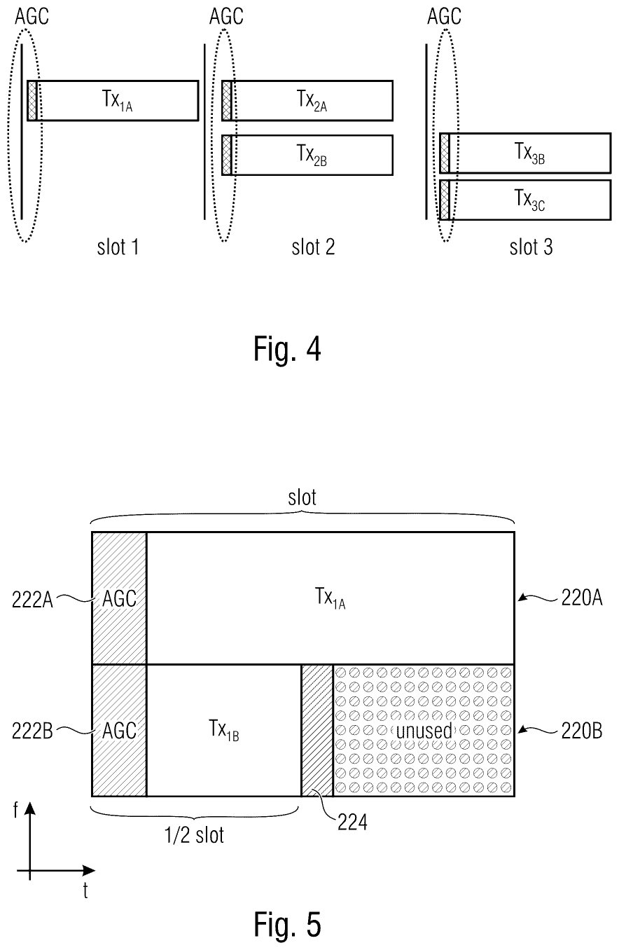

For a communication using the sidelink, the respective entities, like the SL-UEs, may employ a SL time slot structure, also referred to as a sidelink frame structure, as shown in FIGS. 3A and B, which illustrates two examples for time slot structures, also referred to as time slot formats. FIG. 3A illustrates a time slot format having one guard symbol, and FIG. 3B illustrates time slot format having two guard symbols. As may be seen from FIG. 3A, the time slot includes 14 symbols. A first symbol is an automatic gain control, AGC, symbol followed by two symbols carrying both the PSCCH and the PSSCH. The fourth symbol is a Demodulation Reference Signal, DMRS, symbol followed by six PSSCH symbols and a further DMRS symbol. The twelfth and thirteenth symbols are also PSSCH symbols and the last symbol is the guard symbol. FIG. 3B illustrates a time slot format in which, again, the first symbol is the AGC symbol followed by three symbols shared by the DMRS, the PSCCH and the PSSCH. The fifth symbol is a DMRS symbol followed by two PSSCH symbols again followed by a further DMRS symbol which, in turn, is followed by two PSSCH symbols. The eleventh symbol is a guard symbol followed by a further AGC symbol for the PSFCH which is transmitted in the thirteenth symbol followed by a further guard symbol.

The time slot format in accordance with FIG. 3A may be used when transmitting/receiving payload data with feedback disabled, for example, for blind transmissions. FIG. 3B illustrates a time slot format which may be used in case a feedback for a transmission from a receiver is to be provided using the PSFCH symbol. Thus, the sidelink frame structure illustrated in FIGS. 3A and B includes at least one guard symbol which is used by a UE to switch from a transmitting, TX, mode to a receiving, RX, mode and vice versa. For example, the time slot according to FIG. 3A may be used by a first UE for sending a transmission and the last symbol, the guard symbol, is used by the first UE so as to switch from the TX mode to the RX mode, for example for receiving a transmission in a subsequent slot from another UE. In FIG. 3B, a first UE may transmit the payload data and switch in the first guard symbol from the TX mode to the RX mode so as to receive in the twelfth and thirteenth symbol a feedback. While the duration of the guard symbol is across one OFDM symbol, as illustrated in FIGS. 3A and B, the actual duration in time may vary depending on the subcarrier spacing, SCS. The actual time needed for a UE to switch between the TX and RX modes in case of a single component carrier, CC, using a CP-OFDM waveform and at least 10 resource blocks, i.e., the AGC setting time, may be as follows:
35 μs for a 15 kHz SCS,
35 μs for a 30 KHz SCS,
18 μs for a 60 KHz SCS.

During the guard symbols, a UE neither transmits nor receives anything, and the guard symbol, as illustrated in FIGS. 3A and B, may occur at the end of the time slot or before the symbols used for the PSFCH as this sending of the PSFCH in the same time slot requires the UE to switch between transmission/reception modes. Within the slots that may be used for the PSSCH transmission, there may be 7 to 14 of the slots reserved for a sidelink operation, among which the PSSCH may be transmitted in 5 to 12 symbols. The remaining sidelink symbols may transmit some or all of the control information, like the PSCCH, the PSFCH, reference symbols, like DMRS, the AGC and the guard symbols.

The AGC symbols described above with reference to FIGS. 3A and B are used during a communication for allowing a receiving UE to adjust its receiver gain, like its amplifiers in a receiver chain, so as to deal with varying receive signal powers.

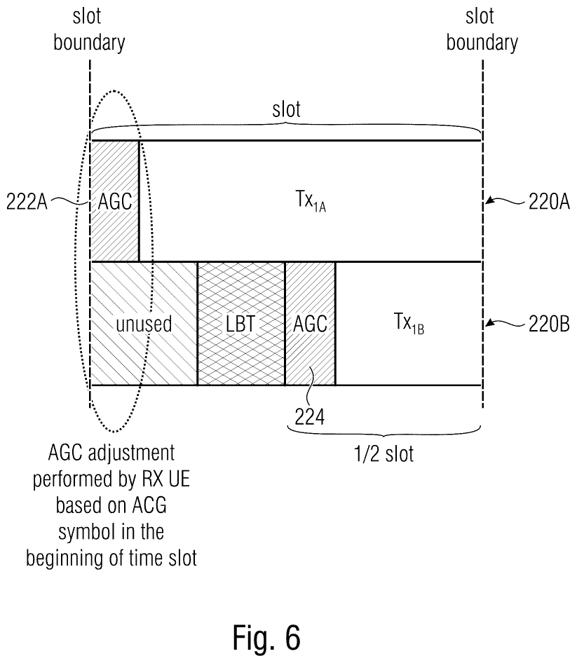

Sidelink transmissions by different UEs may be performed in different time slots that are aligned in the frequency domain across multiple subchannels. FIG. 4 illustrating multiple time slots with transmissions aligned in the frequency domain. More specifically, three time slots, referred to as slot 1, slot 2 and slot 3 are depicted. The respective slot boundaries are schematically illustrated by the vertical lines at the beginning of slot 1, between slot 1 and slot 2, and between slot 2 and slot 3. A first UE, UE1, performs one transmission Tx_{1A} during the first time slot using a time slot structure as described above with reference to FIGS. 3A and B. The first symbol is the AGC symbol so as to allow a UE receiving the transmission Tx_{1A} from UE1 to adjust its receiver. In time slot 2, a second UE, UE2, performs two transmissions, a first transmission Tx_{2A} in a first frequency band or frequency subband, and a second transmission Tx_{2B} in a second frequency band or subband. The transmissions may use the time slot structure as described above with reference to FIGS. 3A and B and both transmissions are aligned in the frequency domain across the frequency bands or subchannels. Again, both transmissions include as the first symbol the AGC symbol, so that the one or more UE receiving the transmissions Tx_{2A} and Tx_{2B} may adjust the receivers gain. In slot 3, a third UE, UE₃, performs two transmissions Tx_{3B} and Tx_{3C}, again in different subbands. Also, for these transmissions, the first symbol of the time slot includes the AGC symbol for allowing an adjustment of the gain of the respective receiving UEs to which the transmissions Tx_{3B} and Tx_{3C} are directed.

As may be seen from FIG. 4, transmissions start only at a slot boundary, and a transmitting UE, TX UE, transmits the AGC symbol in the first symbol of the time slot. The content of the AGC symbol may be a simple copy of the content of the following symbol which may be a combination of a PSCCH and either a DMRS or a PSSCH, dependent on whether the time slot structure illustrated in FIG. 3A or the one illustrated in FIG. 3B is used. The AGC symbol at the beginning of each time slot allows all receiving UEs, RX UEs, to adjust the gain of their receivers, thereby minimizing or reducing quantization noise and preventing a saturation of the receiver chain, for example, at the analog-digital-converter, ADC.

There may be situations in which a channel which is currently used by a certain transmitting entity becomes free, for example because the transmitting entity completed its transmission before the end of the time slot. Thus, the time at which the channel becomes free may be any time during the duration of a time slot. For example, consider mini-slot transmissions which occupy only a part of a slot. There may be more than one starting symbol position configured, which enables a UE to start at a second starting symbol position which may be not aligned with the slot boundary, e.g., beginning in the middle of a slot or half-slot. In addition, systems may support multi-consecutive slot transmissions (MCSt), which allow to aggregate slots and partial slots, e.g., slots and mini-slots or slots and partial slots which start at a symbol position being different to the first symbol of a slot. In such cases, a MCSt transmission may terminate at a symbol position other than the slot boundary, which also enables other UEs to start a transmission within any symbol within a slot. Also, when performing sidelink communications in the unlicensed spectrum, a currently occupied frequency band, subband or channel may become free as another device, either from a system using the same Radio Access Technology, RAT, as the SL-UE or from a system using a different RAT, like a WiFi or Bluetooth device, completed a transmission so that there is basically the possibility to acquire the now free channel at any time during a time slot.

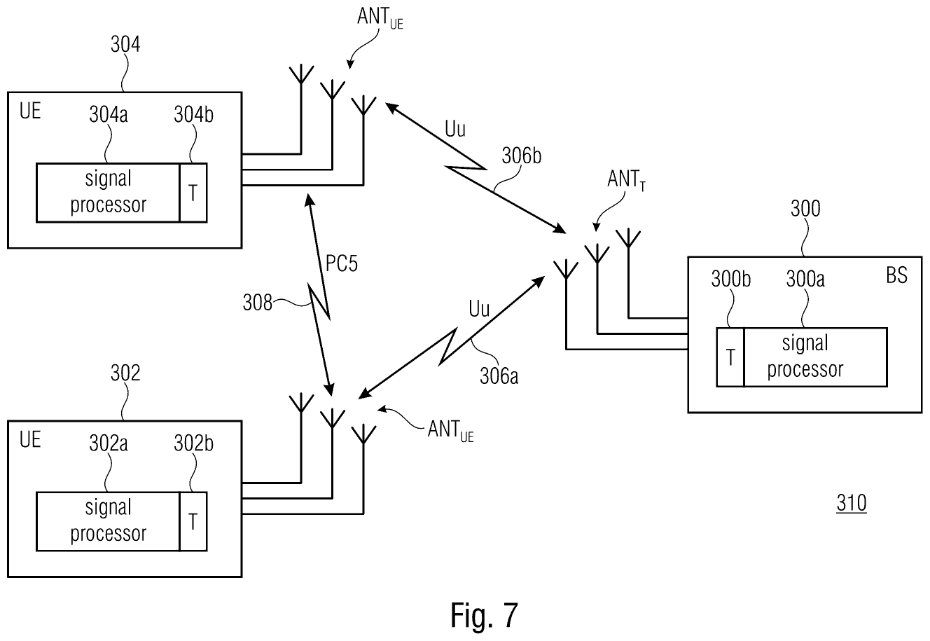

FIG. 5 illustrates a scenario assuming a sidelink UE to perform two transmissions Tx_{1A} and Tx_{1B} in adjacent channels or frequency bands 220A and 220B using a time slot structure as illustrated in FIG. 3A. The transmissions Tx_{1A} and Tx_{1B} are aligned in the frequency domain so as to start at the slot boundary, and the initial symbol is the AGC symbol 222A, 222B so as to allow the one or more receiving UEs to adjust their receivers accordingly. It is assumed that the first transmission Tx_{1A} extends over the entire duration of the time slot, also referred to herein as full-slot transmission, whereas the second transmission Tx_{1B} includes less data to be transmitted and, therefore, is terminated before the end of the time slot leaving a part of the time slot in a second channel 220B unused. The second transmission Tx_{1B} is also referred to herein as a partial-slot or sub-slot transmission. The first transmission Tx_{1A} makes use of the full slot, whereas the second transmission Tx_{1B} makes use of only a part of the slot, for example only of the first seven symbols, and is also referred to herein as a half-slot transmission. When considering the scenario of FIG. 5, in accordance with which full-slots and half-slots are aligned at the beginning of the time slot, this results in a waste of resources as a UE has to wait for its next transmission to begin at the next start of a time slot. This is illustrated in FIG. 5, in accordance with which the second part of the time slot in the second frequency band 220B is not used, i.e., the resources are wasted. Such a scenario may occur for operations in an unlicensed spectrum, since the UE performing the transmissions in FIG. 5, has a COT for a transmission of its half-slot and may miss its transmission opportunity, for example, in case the COT may not be extended to the next full slot.

To address such situations, it has been agreed to allow using additional transmission starting times. For example, a time slot may support at least two starting symbols, where each of these starting symbols may be used for AGC purposes. This essentially means that there is a full slot structure and a sub-slot structure which begins at a configured or pre-configured symbol within a time slot, where the first symbol for both structures is used for AGC purposes. Introducing such additional starting symbols for AGC purposes result in a more flexible position of the AGC symbols, thereby enabling UEs to start a transmission at a certain symbol within the time slot, thereby avoiding the waste of resources. For example, when considering the above-described situation in the unlicensed spectrum, additional AGC symbols may enable UEs to better utilize an existing COT and thus increase system efficiency in terms of a higher throughput, a lower delay and the like. Also, data traffic having delay constraints according to a packet delay budget, PDB, may benefit from such additional AGC symbols. Two or more additional starting symbols may be provided which are provided with respective offsets from the first starting symbol. The first stating symbol may be a first symbol in the time slot or a later symbol in the time slot.

FIG. 5 illustrates a time slot structure to be used for a transmission in the second frequency band 220B which includes, in addition to the AGC symbol 222B at the beginning of the time slots, an additional AGC symbol 224. The two AGC symbols 222B, 224 are starting positions at which a transmitting UE may start a transmission. For example, when considering the situation in the unlicensed spectrum in which the second frequency band 220B is determined to be occupied at the beginning of the time slot but is then determined to have become free, the UE does not need to wait until the next slot boundary for starting the transmission Tx_{1B}, rather, it may take advantage of the additional starting symbol 224 and start its transmission Tx_{1B} during the current time slot at the symbol 224. Another scenario in which this may be applied is that the actual data to be transmitted in the second transmission Tx_{1B} only becomes available at the transmitting UE at some time during the slot. Also, in such a situation, the UE may take advantage of the additional starting symbol 224 and start the transmission Tx_{1B} in the second half of the slot.

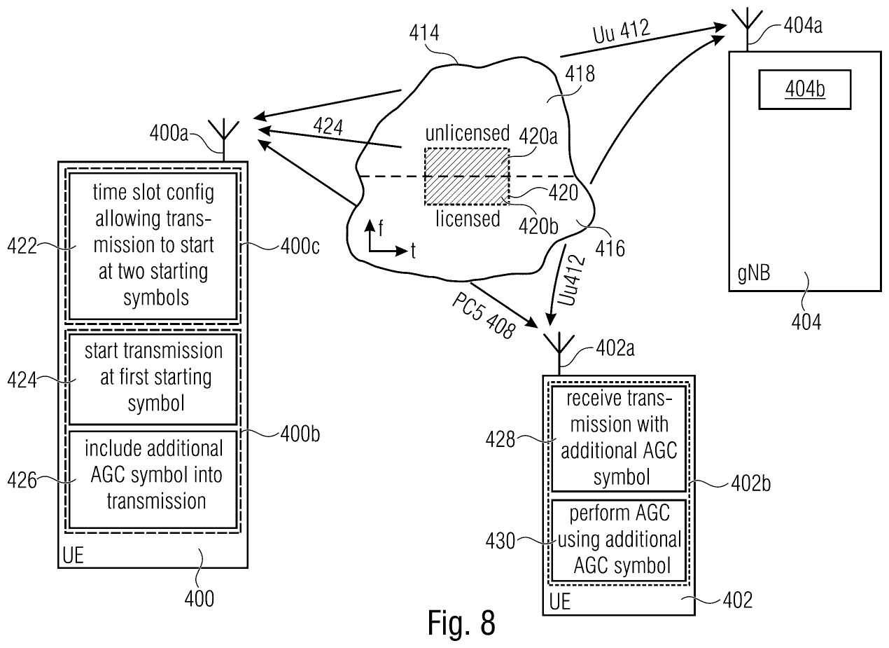

FIG. 6 illustrates such a situation in more detail. It is assumed that the UE performs two transmissions Tx_{1A} and Tx_{1B}. It is further assumed that in channel 220A the transmission Tx_{1A} is performed using a time slot structure according to FIGS. 3A and B, whereas in channel 220B a time slot structure may be used for the transmission Tx_{1B} which has a structure as in FIGS. 3A and B, but includes, for example in the seventh symbol, an additional AGC symbol 224 acting as a second starting symbol or starting position. Thus, in a situation as described above, e.g., a situation in which the channel or data to be transmitted during transmission Tx_{1B} is not available at the beginning of the slot but becomes available at a later time during the slot, a first part of the slot in the second frequency band 220B remains unused. However, once the UE becomes aware that the channel or the data to be transmitted is available, a channel access procedure, like an LBT procedure, may be performed. If it is determined that the channel 220B is available, i.e., is not occupied by any other transmitting entity, the UE may take advantage of the additional starting position 224 and start the transmission Tx_{1B} during the second half of the slot. It is noted that the second starting symbol is not necessarily in the middle of the time slot, for example in the seventh symbol, it may actually be any symbol within the time slot that is configured or preconfigured, for example as part of the system or resource configurations. Note, the exact position of the second starting symbol may also depend on the specific time slot structure, e.g., it may depend on whether feedback (PSFCH) is enabled for the given slot or channel/sub-channel/interlace/RB Set, or whether PSFCH is disabled. In slot structures with PSFCH enabled, it may be more efficient to configure or preconfigure the second starting symbol position at an earlier symbol between the first symbol of a slot and the middle symbol of a slot, in order to increase the number of data symbols (PSSCH) which may be transmitted in such a slot. This is due to the large number of symbols in a PSFCH-enabled slot or half-slot which are already occupied by two guard symbols, an additional AGC symbol, as well as by the symbol used for PSFCH and thus only allows to transmit PSSCH on one or two symbols within the slot. Also the first starting symbol is not necessarily the first symbol of the time slot. It is just the symbol in the slot at which an earliest transmission may be started. The first starting symbol may also be any other symbol following the first symbol in the time slot.

However, providing no additional AGC symbols within a time slot structure when configured with other time slot structures with additional starting symbols, results in the starting of transmissions during ongoing transmissions in other subbands, for example midway into a time slot, and this may lead to a clipping because RX UE did not have the possibility to tune its ADCs using an additional AGC symbols accordingly, which may lead to a not correctly adjusted gain control. For example, when considering FIG. 6, the UE transmits an initial AGC symbol in the first frequency band 220A, and receiving UEs perform a corresponding AGC adjustment based on this AGC symbol at the beginning of the time slot. However, the UE transmits, in the example of FIG. 6, a further AGC symbol halfway through the slot, which allows a receiving UEs which is aware of the additional AGC symbol to perform an additional gain adjustment according to the further AGC symbol 224 also in the middle of the slot. Without this additional AGC symbol, a RX UE does not have time as well as know the RX power required to tune its ADC correctly prior to reception of the PSCCH/PSSCH/DRMS/PSFCH. Thus, the said UE may not avoid saturation at its receiver in case the receive power is too high, or fail decoding the data, in case its receive power is too low and in case its RX amplifier is not configured accordingly.

Further, when taking advantage of the additional starting symbol, the UE having the first transmission Tx_{1A} starting at the beginning of the time slot and the second transmission Tx_{1B} starting at the second starting symbol, a receiver UE that is trying to adjust its receiver gain may not be able to perform the adjustment correctly, as the RX UE performs an initial adjustment on the basis of the AGC symbol at the beginning of the time slot for the first transmission in the frequency band 220A but may not be aware of the additional AGC symbol 224 so that no AGC is performed by the receiving UE for the second transmission resulting in power variations associated with the second transmission Tx_{1B}. Also, in case the receiving UE performs an additional AGC responsive to the AGC symbol 224 for the second transmission, this may cause a spike or peak in the power causing a saturation of the receiver at the receiving UE.

In other words, the above-described conventional approach of simply introducing an additional starting time into a time slot so as to allow a transmitting UE to start its transmission either at the slot boundary, i.e. at the beginning of the time slot or at one or more other symbols during the duration of the time slot causes further problems, e.g., the mentioned power adjustment problems in the receiving UEs, because the receiving UEs only perform the power adjustment on the basis of the initial AGC symbol in the time slot or after the guard symbol of a PSFCH-enabled slot, thereby causing power variations for the different transmissions started at a later time during the time slot.

To address the above-described problems emerging with the use of providing additional starting times during a time slot, in accordance with the present invention, a sidelink UE that is to perform a transmission using a time slot structure allowing a transmission to be starting at one of a plurality of starting symbols during the duration of the time slot and which starts the transmission at the first starting symbol includes an additional AGC symbol at a position in the time slot corresponding to the second starting symbol. In other words, dependent on the configured or preconfigured additional starting symbol position, an additional AGC symbol is introduced into a full time slot structure, at the same symbol position as the second starting position within the time slot. Worded differently, in accordance with the inventive approach, an additional AGC symbol is introduced at a starting symbol of a sub-slot transmission.

The inventive approach is advantageous as it avoids the above-described problems with transmitting AGC symbols at different times during the slot duration among which a receiving UE may only take into consideration a first AGC symbol or, when considering both AGC symbols, may cause problems at the receiving stage of the receiving UE, for example due to a situation of the receivers. Providing the additional AGC symbols at the same position during the time slot as the second starting point ensures that receiving UEs may adjust their receive gain, e.g., by adjusting the receive power, and thus avoid saturation at the ADC, e.g., clipping at the ADC. This is required for successfully decoding and receiving PSCCH/PSSCH/PSFCH/DMRS.

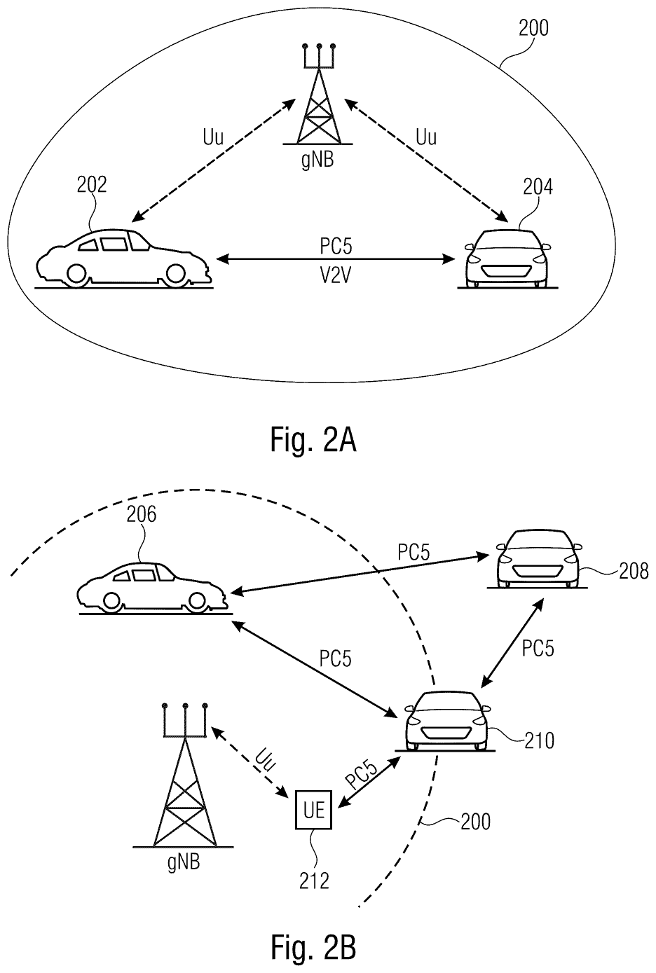

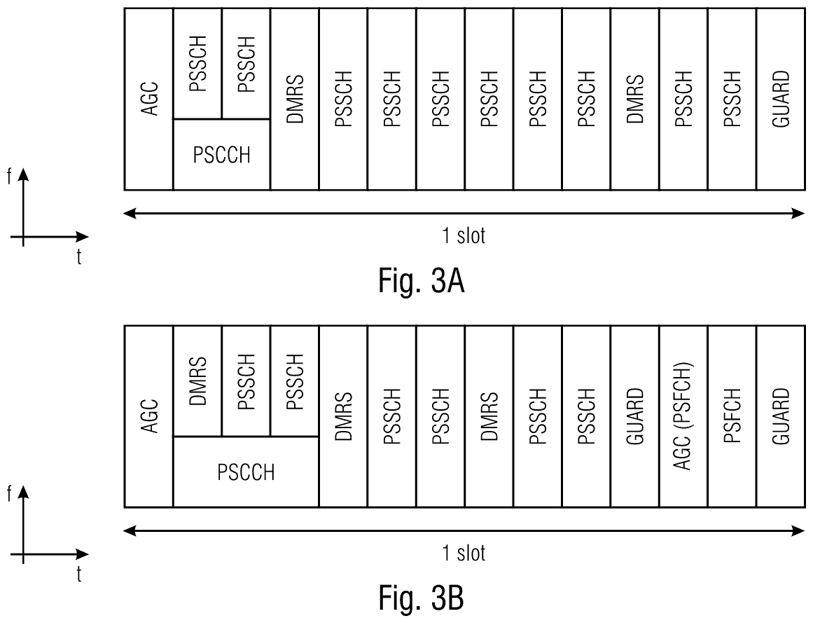

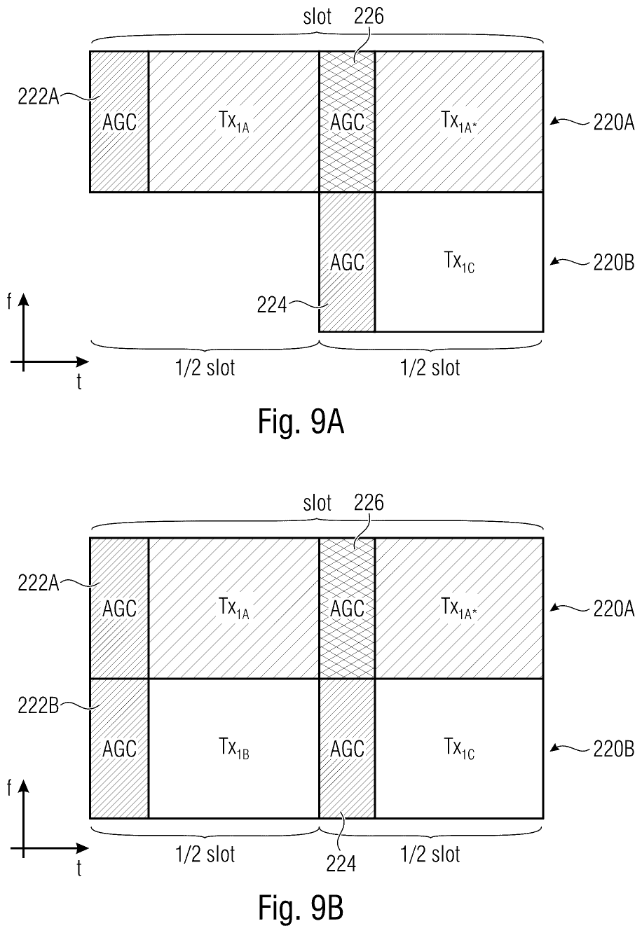

Embodiments of the present invention may be implemented in a wireless communication system as depicted in FIGS. 1A and B, FIG. 2A or FIG. 2B including base stations and users, like mobile terminals or IoT devices. FIG. 7 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 7, the one or more UEs 302, 304 of FIG. 7, and the base station 300 of FIG. 7 may operate in accordance with the inventive teachings described herein.

### Transmitting UE

The present invention provides a user device, UE, for a wireless communication network, like a 3^{rd} Generation Partnership Project, 3GPP, network,
wherein the UE is to communicate with one or more further UEs in the wireless communication network over a sidelink, SL,
wherein the UE is configured or preconfigured with a time slot structure allowing a transmission to be started at one of a plurality of starting symbols during a duration of a time slot, the plurality of starting symbols including a first starting symbol and a second starting symbol, the first starting symbol being an automatic gain control, AGC, symbol and the second starting symbol being an AGC symbol and being offset from the first starting symbol,
wherein the UE is to start a transmission at the first starting symbol or at the second starting symbol, and
wherein, when the UE starts the transmission at the first starting symbol, the UE is to include into the time slot an additional AGC symbol, the additional AGC symbol being at a symbol of the time slot corresponding the second starting symbol.

In accordance with embodiments, the first starting symbol is at the beginning of the time slot.

In accordance with embodiments, the UE is configured or preconfigured with the time slot structure according to one or more of the following:
per resource pool,
per Bandwidth part,
per subband,
per a set of subbands, e.g., per sub-channel or interlace in an unlicensed spectrum,
a system wide configuration, e.g., using a broadcast message like a System Information Block, SIB and/or a Master Information Block, MIB,
per transmission,
per a set of transmissions.

In accordance with embodiments, the time slot comprises a plurality of symbols, the first starting symbol is a first symbol in the time slot, thereby allowing a transmission to use a full slot, and the second starting symbol is a second symbol of the time slot or is a symbol offset from the first symbol by one or more symbols, thereby allowing a transmission to use a partial slot.

In accordance with embodiments, the second starting symbol is at the middle of the time slot, e.g., at symbol position seven, thereby allowing a transmission to use a half slot.

In accordance with embodiments, the UE is configured or preconfigured with a time slot structure and the additional AGC symbol is configured or preconfigured
in every time slot within a SL resource pool, or
only in a proper subset of time slots within the SL resource pool.

In accordance with embodiments, the proper subset of time slots is configured or preconfigured
using a time pattern, like a bitmap, or
using a periodic pattern, e.g., including a periodicity and/or a length of the pattern, or
using an asymmetric pattern, or
using a starting symbol and/or a periodic offset, or
using a time resource indicator value, TRIV, and/or a frequency resource indicator value, FRIV, or
dependent on whether a certain symbol, like a Physical Sidelink Feedback Channel PSFCH, is present or absent in the time slot.

In accordance with embodiments, the UE is to use the additional AGC symbol
for all transmissions, or
only for one or more certain transmissions.

In accordance with embodiments, the UE is allowed to start at the second starting symbol
for all transmissions, or
only for one or more certain transmissions.

In accordance with embodiments, the one or more certain transmissions comprise one or more following:
a new transmission,
a transmission having a priority exceeding a predefined threshold,
a transmission having certain delay constraints, such as Ultra reliable low latency communication, URLLC, constraints, e.g., according to a Packet Delay Budget, PDB, of the transmission, a transmission for which the UE has successfully performed a channel access procedure, like a Listen-Before-Talk, LBT, on a subchannel,
a transmission comprising of positioning information, e.g., including one or more positioning reference symbols, PRSs,
a PSFCH transmission, e.g., a standalone PSFCH transmission without data, for transmitting urgent feedback like a Hybrid Automatic Repeat Request, HARQ, feedback,
a transmission of an assistance information message, AIM, or an inter-UE coordination messages, IuC,
a transmission comprising of control information, e.g., a MAC-CE which is transmitted within a Physical Sidelink Shared Channel, PSSCH,
a transmission comprising of one or more additional Demodulation Reference Signals, DRMS, or of channel state information, CSI, e.g., to be used for pre-coding or decoding of Multiple Input Multiple Output, MIMO, transmissions, a transmission preceding a reserved transmission in a following full time slot.

In accordance with embodiments,
a last symbol of the time slot comprises a guard symbol, and
the UE is to use the guard symbol for a data transmission, e.g., for the transmission of a Physical Sidelink Shared Channel, PSSCH, or a Physical Sidelink Feedback Channel, PSFCH, or a Physical Sidelink Control Channel, PSCCH, or a Demodulation Reference Signal, DMRS,
when the UE starts the transmission at the first starting symbol in a current time slot using the additional AGC symbol or at the second starting symbol in the current time slot, and
when the UE is to also transmit in a following time slot, or, at the end of the current time slot, is to enter a Discontinuous Reception, DRX, mode.

In accordance with embodiments,
a first time slot structure is the time slot structure allowing the transmission to be started at one of the plurality of starting symbols, and a second time slot structure is a time slot structure allowing the transmission to be started only at the first symbol of a time slot, and
when the UE starts the transmission at the first starting symbol in a current time slot using the additional AGC symbol and is to perform a transmission in a following time slot, the following time slot has the first time slot structure or the second time slot structure, or
when the UE starts the transmission at the second starting symbol in a current time slot and is to perform a transmission in a following time slot, the following time slot has
   the first time slot structure, or
   the second time slot structure, or
   a third time slot structure, the third time slot structure allowing a first transmission to be started at a first starting symbol during a duration of the following time slot, and allowing a second transmission to be started at a second starting symbol following the first starting symbol during the duration of the following time slot, or
   a fourth time slot structure, the fourth time slot structure allowing the transmission in the current time slot to be extended into the following time slot without an AGC symbol and/or a control symbol at the beginning of the following time slot.

In accordance with embodiments,
the UE is to use a first time slot structure and a second time slot structure for a transmission,
the first and second time slot structures are using
   the same frequency, or
   a different frequency,
the frequency is defined as one or more of a subchannel, a set of subchannels, a sub-band, a set of sub-bands, an interlace, a resource block set, a set of interlaces, a resource pool, a set of resource pools.

In accordance with embodiments, the second starting symbol and the additional AGC are located ahead of a predefined symbol in the time slot by a configured or preconfigured number of one or more symbols, like a DMRS symbol.

In accordance with embodiments,
the time slot structure includes a predefined number of symbols at the end of the time slot which are dedicated for receiving a transmission, such as a feedback transmission, e.g., a first guard symbol, an AGC symbol for the PSFCH, the PSFCH symbol, and a second guard symbol, and
the second starting symbol is offset from a first symbol of the predefined number of symbols, and the UE is to use the one or more symbols between the second starting symbol and the first symbol of the predefined number of symbols for a certain transmission, e.g.,
a transmission of dummy data to retain a Channel Occupancy Time, COT, initiated after performing a Listen Before Talk, LBT, or
a transmission of a predefined reference symbol, e.g., a positioning reference symbols, PRS, used for sidelink positioning, or a reference symbol for a channel reconstruction, like a DRMS, or
a transmission of channel state information, CSI, e.g., a CSI reference symbol, CSI-RS, for improving a Multiple Input Multiple Output, MIMO, channel estimation a transmission of assistance information message, AIM, or inter-UE coordination messages, IuC,
a transmission comprising of control information, e.g., a MAC-CE which is transmitted within the PSSCH.

In accordance with embodiments, the UE is to use one or more symbols between the second starting symbol and the end of the time slot for a certain transmission, e.g.,
a transmission for which the UE has successfully performed LBT on the subchannel,
a PSFCH transmission, e.g., a standalone PSFCH transmission without data, for transmitting urgent feedback like HARQ-feedback,
a transmission of dummy data to retain a Channel Occupancy Time, COT, initiated after performing a listen before talk, LBT, or a transmission of a predefined reference symbol, e.g., a positioning reference symbols, PRS, used for sidelink positioning, or a reference symbol for a channel reconstruction, like a DRMS, or
a transmission of channel state information, CSI, e.g., a CSI reference symbol, CSI-RS, for improving a Multiple Input Multiple Output, MIMO, channel estimation
a transmission of assistance information message, AIM, or inter-UE coordination messages, IuC,
a transmission comprising of control information, e.g., a MAC-CE which is transmitted within the PSSCH.

In accordance with embodiments, the UE is to perform the certain transmissions in a configured or preconfigured resource pool having a PSFCH periodicity greater than one, e.g., two or four.

In accordance with embodiments, a first control channel, like a first PSCCH, is transmitted at the beginning of the current time slot, and/or a second control channel, like a second PSCCH, is transmitted at the beginning of the following time slot.

In accordance with embodiments, the UE is to transmit control information only in the first control channel, like a first PSCCH, wherein the control information includes information about the data transmission, including a PSSCH and/or a PSFCH, extending into the following time slot, e.g., by indicating in a SCI the number of time slots for which the data transmission is extended, and whether the following time slots use a full slot structure or a partial slot structure.

In accordance with embodiments, the UE is to transmit control information only in the second control channel, like a second PSCCH, wherein the control information includes information about the data transmission, like a PSSCH, extending into the preceding time slot, e.g., by indicating in a SCI the number of preceding time slots or partial time slots for which the data transmission is extended, and whether the preceding time slots use a full slot structure or a partial slot structure.

In accordance with embodiments, the first and/or second PSCCHs include one or more of the following:
control information pointing to data, like a PSSCH, transmitted across the current and following time slots,
respective first stage Sidelink Control Information, SCIs, the first and second SCIs being independent and including, e.g., respective reservation fields pointing to a main slot resource allocation, or being copies of each other,
additional information, like a sub slot indicator indicating a partial time slot to belongs to a current resource allocation.

In accordance with embodiments, the PSSCH following the first/or second PSCCHs includes respective second stage SCIs in a PSSCH of both the current and following time slots, or only one second stage SCI in a PSSCH of one of the current and following time slots.

In accordance with embodiments, the UE is to communicate with the one or more further UEs over the SL using a set of resources in an unlicensed spectrum.

In accordance with embodiments, when the UE starts the transmission at the second starting symbol, the UE is to perform a listen before talk, LBT, procedure during one or more symbols preceding the second starting symbol.

In accordance with embodiments, the time slot structure allows to be started at at least one further starting symbol during the duration of the time slot.

In accordance with embodiments, the UE is configured with the time slot structure by one or more network entities of the wireless communication system.

In accordance with embodiments, the network entity of the wireless communication system comprises one or more of the following:
a base station, like a macro cell base station, or a small cell base station, or a central unit of a base station, or a distributed unit of a base station, or an Integrated Access and Backhaul, IAB, node,
a road side unit, RSU,
a UE, like a SL UE, or a group leader UE, GL-UE, or a relay UE,
a remote radio head,
a core network entity, like an Access and Mobility Management Function, AMF, or a Service Management Function, SMF, or a mobile edge computing, MEC, entity,
a network slice as in the NR or 5G core context,
any transmission/reception point, TRP, enabling an item or a device to communicate using the wireless communication network, the item or device being provided with network connectivity to communicate using the wireless communication network.

In accordance with embodiments, the UE is preconfigured with the time slot structure, e.g., by based on a hard-coded configuration in the UE.

### Receiving UE

The present invention provides a user device, UE, for a wireless communication network, like a 3^{rd} Generation Partnership Project, 3GPP, network,
wherein the UE is to communicate with one or more further transmitting UEs according embodiments of the present invention,
wherein the UE is to receive a transmission from a transmitting UE including an additional AGC symbol being at a symbol of the time slot corresponding to the second starting symbol, and
wherein the UE is to perform a gain control procedure at the additional AGC symbol.

In accordance with embodiments, the presence of an additional AGC symbol at the second starting symbol is indicated by one or more of
a control signaling together with a signaling and/or a configuration of the transmission, e.g., a SCI field indicating the additional AGC symbol, or a pre-configuration of the PSFCH indicator indicating an absence of the PSFCH,
a resource pool configuration,
a configuration,
a pre-configuration.

In accordance with embodiments, the signaling and/or the configuration or the pre-configuration is indicated according to one or more of the following:
per resource pool,
per Bandwidth part,
per subband,
per a set of subbands, e.g., per sub-channel or interlace in an unlicensed spectrum,
a system wide configuration, e.g., using a broadcast message like a System Information Block, SIB and/or a Master Information Block, MIB,
per transmission,
per a set of transmissions.

In accordance with embodiments, the signaling and/or the configuration is indicated by one or more network entities of the wireless communication system.

In accordance with embodiments, the network entity of the wireless communication system comprises one or more of the following:
a base station, like a macro cell base station, or a small cell base station, or a central unit of a base station, or a distributed unit of a base station, or an Integrated Access and Backhaul, IAB, node,
a road side unit, RSU,
a UE, like a SL UE, or a group leader UE, GL-UE, or a relay UE,
a remote radio head,
a core network entity, like an Access and Mobility Management Function, AMF, or a Service Management Function, SMF, or a mobile edge computing, MEC, entity,
a network slice as in the NR or 5G core context,
any transmission/reception point, TRP, enabling an item or a device to communicate using the wireless communication network, the item or device being provided with network connectivity to communicate using the wireless communication network.

In accordance with embodiments, the pre-configuration is based on a hard-coded configuration in the UE.

In accordance with embodiments, a first control channel, like a first PSCCH, is received at the beginning of the current time slot, and/or a second control channel, like a second PSCCH, is received at the beginning of the following time slot.

In accordance with embodiments, the UE is to receive control information only in the first control channel, like a first PSCCH, wherein the control information includes information about the data transmission, including a PSSCH and/or a PSFCH, extending into the following time slot, e.g., by indicating in a SCI the number of time slots for which the data transmission is extended, and whether the following time slots use a full slot structure or a partial slot structure.

In accordance with embodiments, the UE is to receive control information only in the second control channel, like a second PSCCH, wherein the control information includes information about the data transmission, like a PSSCH, extending into the preceding time slot, e.g., by indicating in a SCI the number of preceding time slots or partial time slots for which the data transmission is extended, and whether the preceding time slots use a full slot structure or a partial slot structure.

### System/Network

The present invention provides a wireless communication system, like a 3^{rd} Generation Partnership Project, 3GPP, system, comprising a one or more user devices, UEs, according to embodiments of the present invention and one or more base stations.

In accordance with embodiments,
the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity, and
the base station comprises one or more of a macro cell base station, or a small cell base station, or a central unit of a base station, or a distributed unit of a base station, or an Integrated Access and Backhaul, IAB, node, or a road side unit, RSU, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method for operating a user device, UE, for a wireless communication network, like a 3^{rd} Generation Partnership Project, 3GPP, network, wherein the UE communicates with one or more further UEs in the wireless communication network over a sidelink, SL, the method comprising:
configuring or preconfiguring the UE with a time slot structure allowing a transmission to be started at one of a plurality of starting symbols during a duration of a time slot, the plurality of starting symbols including a first starting symbol and a second starting symbol, the first starting symbol being an automatic gain control, AGC, symbol and the second starting symbol being an AGC symbol and being offset from the first starting symbol,
starting, by the UE, a transmission at the first starting symbol or at the second starting symbol, and
when the UE starts the transmission at the first starting symbol, including, by the UE, into the time slot an additional AGC symbol, the additional AGC symbol being at a symbol of the time slot corresponding the second starting symbol.

### Computer Program Product

Embodiments of the present invention provide a computer program product comprising instructions which, when the program is executed by a computer, causes the computer to carry out one or more methods in accordance with the present invention.

Embodiments of the present invention are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols,
one or more time slots or subframes or frames,
one or more frequencies or carriers or subchannels or group of subchannels,
one or more interlaces,
one or more resource block sets, RB sets,
one or more frequency bands, like unlicensed subbands,
one or more bandwidth parts,
one or more resource pools,
one or more LBT sub-bands,
one or more spatial resources, e.g., using spatial multiplexing.

Furthermore, it is noted that when referring to “a set of resources”, in this description, a set of resources may contain one or more than one resource, with the definition of a resource as mentioned above. Moreover, it is noted that when referring to a “channel”, in this description, this may refer to a set of the resources as mentioned above. Thus, a “channel” may also refer to a sub-channel, a sub-band, an RB set, an interlace, a resource pool or a SL BWP.

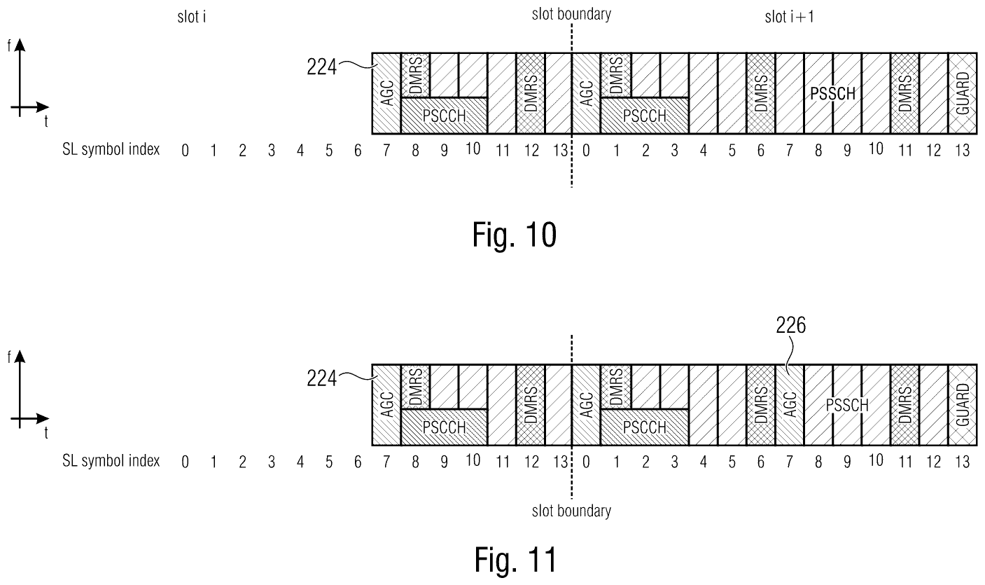

FIG. 8 illustrates a wireless communication system, like the one described above with reference to FIGS. 1A and B, FIGS. 2A and B and FIG. 7, for example a 3^{rd} generation partnership project, 3GPP, system or network. The wireless communication system includes user devices 400, 402 and one or more base station 404 operating in accordance with embodiments of the present invention. UE 400, also referred to as sidelink UE, SL-UE, comprises one or more antennas 400a and a signal processor 400b for performing one or more operations, for example operations involving the antenna 400a, like transmitting/receiving data, e.g., payload data or control data, or inter-UE coordination (IUC) messages. UE 400 may communicate with other UEs, like UE 402, using the sidelink or PC5 interface, as is schematically illustrated at 408. UE 402, also referred to as sidelink UE, SL-UE, comprises one or more antennas 402a and a signal processor 402b for performing one or more operations, for example operations involving the antenna 400a, like transmitting/receiving data, e.g., payload data and/or control data, or inter-UE coordination (IUC) messages. Moreover, UE 400 and/or UE 402 may be connected to a base station or gNB 404. The gNB 404 includes one or more antennas 404a for the wireless communication with the other network entities, like UEs 400 and/or 402, and a signal processor 404b. When operating in Mode 1, UE 400 and UE 402 receive via the Uu interface 412 resources allocated by the gNB 404 that are to be used by the UE for the communication over the sidelink 408. As mentioned above, when operating in Mode 2, UE 400 and/or UE 402 may not have a connectivity to the gNB 404 and a sensing plus access resource allocation or a random access-based resource allocation is performed by the UE prior to performing a transmission.

FIG. 8 further illustrates, schematically, the spectrum 414, like the radio spectrum including the resources to be used for a communication within the wireless communication system or network. The resources available for the SL communication may comprise one or more of the following: one or more symbols, one or more time slots or subframes or frames, one or more resource blocks (RBs) or frequencies or carriers or subchannels or groups of subchannels, one or more frequency bands. As is further illustrated, schematically, the spectrum 414 comprises the licensed spectrum 416 and the unlicensed spectrum 418. The licensed spectrum 416 is the part of the spectrum that is reserved for the wireless communication system including the UEs 400 and 402 as well as the base station 404. In other words, resources in the licensed spectrum are for exclusive use by this wireless system, as defined by regulatory bodies and entities. The unlicensed spectrum 418 includes resources that may be used by a plurality of wireless communication systems, for example by another wireless communication system in accordance with the 3GPP standard but operated by a different operator, or by systems using a different radio access technology, RAT, like WiFi or Bluetooth.

In accordance with embodiments, for the sidelink communication a resource pool 420, also referred to as sidelink resource pool, SL-RP, may be provided, and UE 400 is configured or preconfigured with the resource pool 420. Although the figure depicts only a single resource pool, multiple such resource pools may be configured or preconfigured. The resource pool may include resources from the unlicensed spectrum 418 only or from the licensed spectrum 416 only, or, as is depicted in the embodiment of FIG. 8, may comprise resources from the licensed spectrum 416 and from the unlicensed spectrum 420. In accordance with further embodiments, the resources in the unlicensed spectrum may be aggregated using carrier aggregation.

In accordance with embodiments of the present invention, UE 400 is configured or preconfigured with a time slot structure allowing a transmission to be started at one of a plurality of starting symbols during a duration of the time slot. For example, a time slot structure as described above with reference to FIG. 3A or FIG. 3B may be employed which, in addition to the AGC symbol at the beginning of the time slot includes an additional AGC symbol, for example at symbol 7 which forms a second starting symbol at which a UE may start a transmission. It is noted that embodiments of the present invention are described herein with reference to the use of one additional starting symbol, i.e., the time slot structure includes a first starting symbol and a second starting symbol, both being AGC symbols, with the first starting symbol being located at the beginning of the time slot, and the second starting symbol being located offset from the first starting symbol. It is noted that the present invention is not limited to the use of only two starting symbols, rather, more than two starting symbols may be included in a time slot, so that an overall number of starting symbols may be 3, 4 or more starting symbols. As is illustrated in FIG. 8, UE 400 includes a storage 400c for storing the inventive time slot configuration allowing a transmission to be started at two or more starting symbols during the time slot, as is schematically indicated at 422. UE 400 may start a transmission at the first starting symbol or at the second starting symbol, both being AGC symbols. As is further indicated at 424, UE 400 starts its transmission at the first starting symbol and, therefore, in accordance with the inventive approach, includes into the time slot the additional AGC symbol at a position which corresponds to the position of the second starting symbol, as is schematically indicated at 426. For example, when considering that the time slot comprises a plurality of symbols, the first starting symbol may be the first symbol in the time slot, thereby allowing a transmission to make use of a full slot, whereas the second starting symbol is a second symbol of the time slot or is a symbol offset from the first symbol by one or more symbols, thereby allowing a transmission to make use of a sub slot. Introducing the additional AGC symbol makes sure that in case a further transmission starts at the second starting symbol, in both transmissions an AGC symbol at the same symbol position is transmitted thereby avoiding the above-described problems at the receiver side.

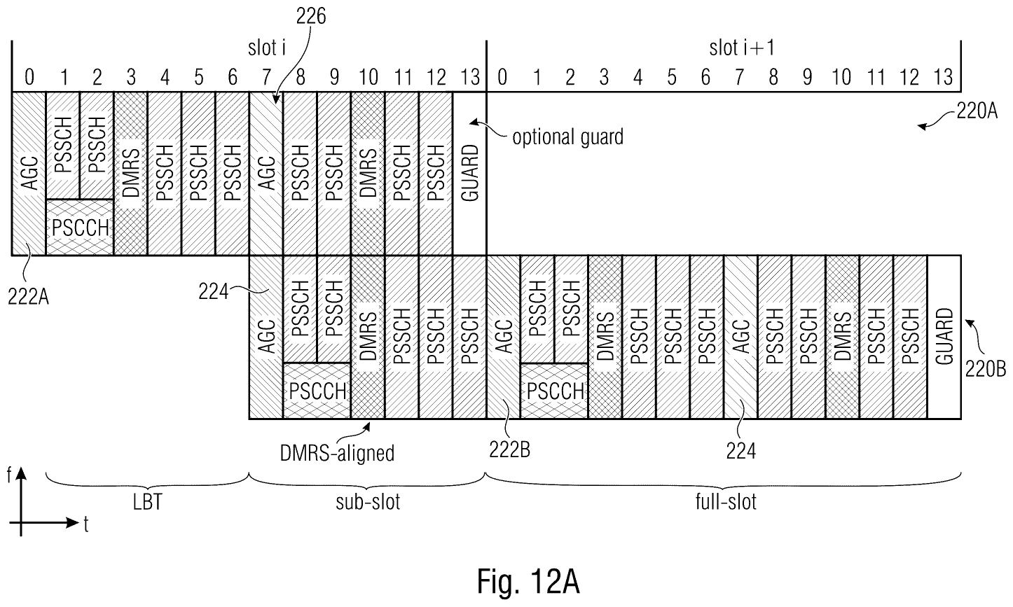

FIG. 9 illustrates an embodiment in accordance with which for a full-slot transmission an additional AGC symbol is included in the middle of the time slot, like at the seventh symbol of a slot having an overall duration of 14 symbols, so that in case a second transmission to be performed in a different frequency band by the UE is started at the second starting symbol, the AGC symbol for the second transmission is aligned with the additional AGC symbol in the first transmission. FIG. 9A illustrates an embodiment in accordance with which UE 400 performs a first transmission Tx_{1A} in the frequency band 220A and a second transmission in a second frequency band 220B. For the first transmission Tx_{1A}, the full time slot is employed, whereas the second transmission Tx_{1c} is occupying only the second half of the time slot. Thus, the scenario in FIG. 9A is similar to the one described above with reference to FIG. 6. However, in accordance with the inventive approach, the problems encountered in the conventional technology approaches are avoided by introducing into the transmission Tx_{1A} performed in the first frequency band 220A an additional AGC symbol 226 at the same symbol location as the second starting symbol 224 in the second frequency band 220B. In the embodiment of FIG. 9A it is assumed that the second starting symbol 224 is at the middle of the time slot, and at the corresponding position the first transmission includes also the additional AGC symbol 226. Thus, the full slot transmission Tx_{1A} now has the additional AGC symbol 226 in the middle of the time slot, the position depending on the configured or preconfigured position of the second starting symbol 224. This enables any RX UE to perform AGC adjustments at this symbol during the duration of the time slot thereby catering to the transmissions carried out only in the second half of the time slot, like transmission Tx_{1C}.

FIG. 9B illustrates a further embodiment, in accordance with which the first half of the time slot in the second frequency band 220B may be used for a further transmission Tx_{1B} which is only the first half of the time slot, and then the second starting symbol 252 may be employed for starting the next transmission Tx_{1C}. Also, in such a scenario the additional AGC symbol 226 is included in the transmission in the first frequency band 220A. For example, the scenario in FIG. 9B may be employed in case the transmissions Tx_{1B} and Tx_{1C} share a COT so that it is not required for the transmission Tx_{1c} to perform an LBT.

In accordance with embodiments, UE 400 is configured or preconfigured with the time slot structure for respective resource pools, i.e., per resource pool, or for respective BWPs, i.e., per BWP, for respective subband or sets of subbands, i.e., per subband or per a set of subbands, e.g., per sub-channel or interlace in an unlicensed spectrum, by a system wide configuration, e.g., using a broadcast message like a System Information Block, SIB and/or a Master Information Block, MIB, or for respective transmissions or sets of transmission, i.e., per transmission, or per a set of transmissions. UE 400 may be configured with the time slot structure by one or more network entities of the wireless communication system, e.g., form one or more of the following:
a base station, like a macro cell base station, or a small cell base station, or a central unit of a base station, or a distributed unit of a base station, or an Integrated Access and Backhaul, IAB, node,
a road side unit, RSU,
a UE, like a SL UE, or a group leader UE, GL-UE, or a relay UE, a remote radio head,
a core network entity, like an Access and Mobility Management Function, AMF, or a Service Management Function, SMF, or a mobile edge computing, MEC, entity,
a network slice as in the NR or 5G core context,
any transmission/reception point, TRP, enabling an item or a device to communicate using the wireless communication network, the item or device being provided with network connectivity to communicate using the wireless communication network.

In accordance with other embodiments UE 400 may be provided with the time slot structure configuration at the time of its manufacture, i.e., it may have a pre-configuration based on a hard-coded configuration. Also, the UE may be preconfigured when being prepared to be used with the wireless communications system, e.g., it may obtain the time slot structure from a SIM inserted into the UE.

In accordance with embodiments, the inventive approach may be employed for every time slot or only for some of the time slots. For example, in accordance with the resource pool or system configurations, the additional AGC symbols may be used in every time slot of a sidelink resource pool. However, providing the additional AGC symbol may result in a reduced number of symbols available for data transmission. Therefore, in accordance with embodiments, the inventive approach of providing the additional AGC symbol may be used only in a proper subset of time slots within a sidelink resource pool or only for one or more certain transmissions. When allowing the use of the additional AGC symbol only for a subset of time slots within a resource pool, only some time slots mandate a UE to use the inventive time slot structure using the additional AGC symbol to be included into a full-slot transmission at position corresponding to any additional starting symbol allowed for the time slot. This enables a UE to transmit using the partial or sub slot in such time slots only so that when performing a full-slot transmission in such a time slot as well, the inventive time slot structure is employed and an additional AGC symbol is introduced into the full-slot transmission so that the RX UE is capable to perform the AGC for adjusting its gain at the receiver chain according to the AGC-symbol transmitted at the starting symbol of the partial transmission. In accordance with embodiments, the subset of time slots may be defined
using a time pattern, like a bitmap, or
using a periodic pattern, e.g., including a periodicity and/or a length of the pattern, or
using an asymmetric pattern, or
using a starting symbol and/or a periodic offset, or
using a time resource indicator value, TRIV, and/or a frequency resource indicator value, FRIV, or
dependent on whether a certain symbol, like a Physical Sidelink Feedback Channel PSFCH, is present or absent in the time slot.

As mentioned above, the use of the additional AGC symbol, i.e., the use of the inventive time slot structure, may be allowed only for one or more certain transmissions. Likewise, in accordance with further embodiments, a transmission may be started at the second starting symbol for all transmissions, or only for one or more certain transmissions. The one or more certain transmissions may comprise one or more following:
a new transmission,
a transmission having a priority exceeding a predefined threshold,
a transmission having certain delay constraints, such as Ultra reliable low latency communication, URLLC, constraints, e.g., according to a Packet Delay Budget, PDB, of the transmission,
a transmission for which the UE has successfully performed a channel access procedure, like a Listen-Before-Talk, LBT, on a subchannel,
a transmission comprising of positioning information, e.g., including one or more positioning reference symbols, PRSs,
a PSFCH transmission, e.g., a standalone PSFCH transmission without data, for transmitting urgent feedback like a Hybrid Automatic Repeat Request, HARQ, feedback,
a transmission of an assistance information message, AIM, or an inter-UE coordination messages, IuC,
a transmission comprising of control information, e.g., a MAC-CE which is transmitted within a Physical Sidelink Shared Channel, PSSCH,
a transmission comprising of one or more additional Demodulation Reference Signals, DRMS, or of channel state information, CSI, e.g., to be used for pre-coding or decoding of Multiple Input Multiple Output, MIMO, transmissions,
a transmission preceding a reserved transmission in a following full time slot.

As has been described above with reference to FIGS. 3A and B, the time slots employed for the sidelink communication may be provided with a guard symbol at the last symbol of the time slot, like symbol number 13. In accordance with the inventive time slot structure, the guard symbol may be maintained when introducing an additional AGC symbol in a way as described above. However, when considering a transmission starting at the second starting symbol 224 and extending into the following time slot, there is no need for the transmitting UE to switch between transmitting/receiving mode, so that the guard symbol is not needed and may actually be employed also for a transmission of data. Thus, the guard symbol at the end of the time slot may be optional dependent on the action the UE carries out in the following time slot. For example, in case the UE needs to receive data in a subsequent time slot, it needs to switch to the reception mode and thus the guard symbol is required. On the other hand, in case the UE continues transmitting, i.e., the transmission started in the current time slot extends into the following time slot it may use the symbol at the end of the time slot for the transmission of additional data, like a PSSCH, a PSFCH, a PSCCH, or a DMRS. Also, in case the UE, following the transmission in the current time slot, switches to DRX mode, i.e., enters sleep mode, the UE needs not to switch to the receiving mode and therefore may use the last symbol for the transmission of additional data.

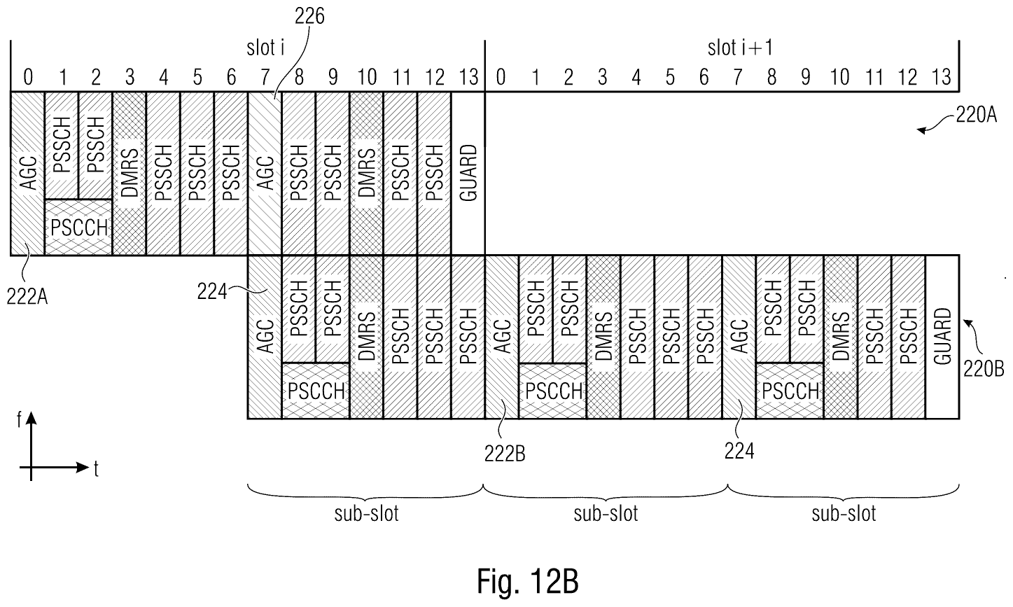

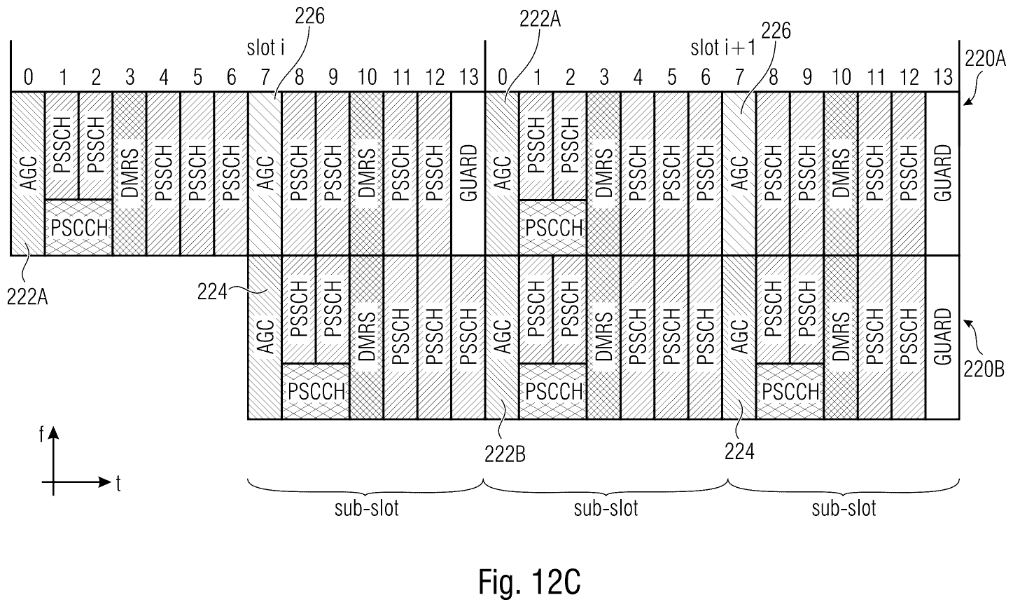

FIG. 10 illustrates an embodiment in accordance with which a transmission is started at the second starting position 224 at symbol 7 of slot i and extends into slot i+1 which is assumed to make use of a time slot structure according to FIG. 3A. In accordance with embodiments, rather than using symbol 13 of slot i as a guard symbol, in accordance with embodiments, this symbol, as is illustrated in FIG. 10, is also used for the transmission of data. FIG. 11 illustrates an embodiment similar to FIG. 10 except that the time slot structure in slot i+1 is a time slot structure in accordance with the present invention including the additional AGC symbol 226 at symbol 7. In other words, FIG. 10 illustrates an embodiment, in which a partial or sub-slot starting at the second starting symbol 224 is followed by a full-slot transmission and in accordance with which the guard in the 13^{th} symbol may be omitted in favor of the transmission of additional data. FIG. 11 illustrates a similar embodiment in accordance with which the partial or sub-slot starting at the second starting symbol 224 of slot i is followed by a full-slot transmission having an additional AGC symbol 226 in the middle of the slot.

In accordance with embodiments of the present invention, the second and any further starting symbol provided in addition to the first starting symbol in the inventive time slot structure may be located at a certain position within the time slot, for example by one or more symbols ahead of a predefined symbol. For example, the second starting symbol may be located three symbols ahead of a DMRS symbol. The additional AGC symbol included into the full-slot transmission is located at the same symbol as the second starting symbol, thereby causing an alignment of the predefined symbols in the respective frequency bands, for example a DMRS alignment across the frequency bands, frequency subbands or subchannels. It is noted that, in accordance with embodiments, different DMRS positions are possible, and more than one or more than two DMRS symbol positions per time slot may be provided.

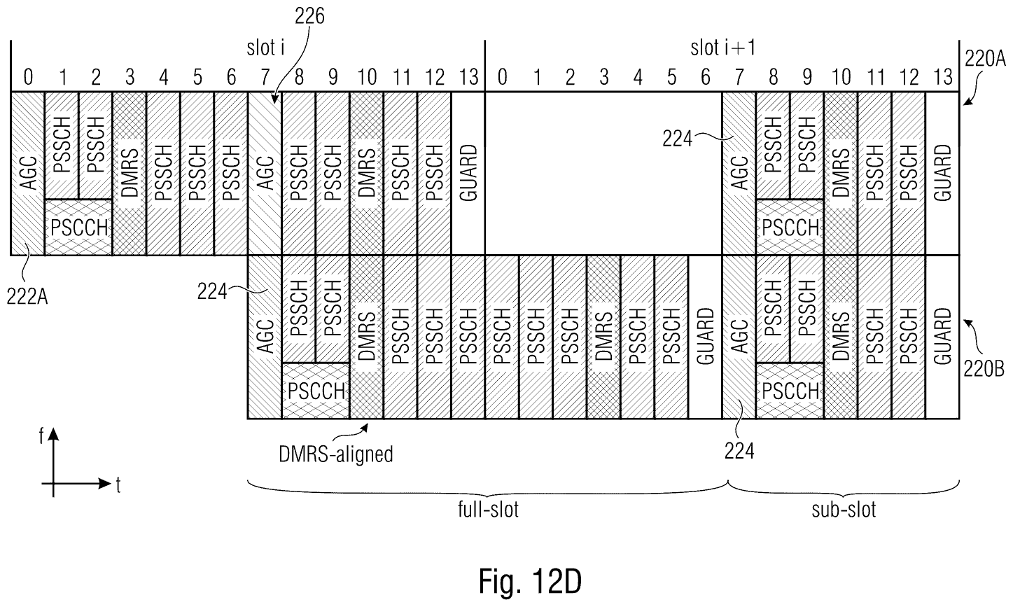

In the following, further embodiments are described concerning the use of the inventive approach for transmitting transmissions in subsequent time slots in different frequency bands. FIGS. 12A, B, C and D illustrate such embodiments in which in a first frequency band 220A a full slot transmission is carried out in a current slot i while a partial or sub-slot transmission is performed in the current time slot i in a second frequency band 220B. In accordance with the inventive approach, since the sub-slot transmission is performed in the frequency band 220B which starts at the second starting symbol 224, the transmission in the first frequency band 220A includes the additional AGC symbol 226 at the same symbol position as the starting symbol 224 in the second frequency band, which is symbol 7 in the depicted embodiment. FIGS. 12A, B, C and D illustrate embodiments in accordance with which the respective transmissions in the two frequency bands 220A and 220B are such that the DMRS-symbols are aligned, i.e., occur in the same symbol in the respective slots. It is noted that the respective transmissions are not necessarily aligned with respect to the DMRS symbol, rather, the assignment may be also with regard to any other symbol. This alignment is due to the fact that the additional starting symbol 224 is provided at a certain position ahead of the DMRS symbol (symbol 10 in FIG. 12A), and since the time slot structures in the two frequency bands are the same except that the transmission starts in the second frequency band 220B at the symbol 224 and since, in accordance with the inventive approach, in the transmission in the first frequency band 220A at the same position as the symbol 224 the additional AGC symbol 226 is inserted. The additional AGC symbol is located at the same distance from the DMRS symbol as in the transmission in the second frequency band so that the respective desired symbols, here the DMRS symbols, are aligned in the frequency bands.

All embodiments depicted in FIG. 12A to FIG. 12D perform in the current slot i a first transmission in the first frequency band 220A covering the entire current time slot while a sub-slot transmission is performed in the second frequency band 220B which starts only at the second starting symbol 224. In accordance with the inventive approach, the full-slot transmission includes the additional AGC symbol 226 at the same symbol as the second starting symbol 224. In accordance with embodiments, as schematically illustrated in FIG. 12A, the first part of the current time slot i in the second frequency band 220B may be used for performing an LBT to see whether the frequency band 220B is available for a transmission.

In FIG. 12A, the transmission in the first frequency band 220A is only during the current time slot i, and there is no transmission in the following time slot i+1. In such a situation, the guard symbol may be used or not, in the latter case, an additional PSSCH or other data may be transmitted there. In the second frequency band 220B, the transmission which started at the second starting symbol 224 may extend into the following time slot i+1, and a full-slot transmission employing a time slot structure according to FIGS. 3A and B or a time slot structure including the additional AGC symbol 226 in accordance with embodiments of the present invention may be employed. In the latter case, i.e., when using the additional AGC symbol 226, an additional transmission (not depicted) may be performed in a further frequency band in the following time slot which is a sub-slot transmission starting at the second starting symbol.

FIG. 12B illustrates an embodiment in accordance with which in the second frequency band 220B two sub-slot transmissions are performed in the following slot i+1, in a similar way as described above with reference to FIG. 9B.

FIG. 12C illustrates an embodiment which is similar to the one of FIG. 12B, however, also in the first frequency band 220A a further transmission is performed in the following time slot i+1. Since the second frequency band 220B transmits in the following time slot i+1 the two sub-slot transmissions, i.e., starts respective transmissions at the first starting symbol and at the second starting symbol 224, the transmission in the first frequency band 220A includes the inventive additional AGC symbol 226.

FIG. 12D illustrates an embodiment in accordance with which in the first frequency band 220A, in the following time slot i+1, a sub-slot transmission is performed starting at the second starting point 224. In the second frequency band 220B, at the end of the following time slot i+1, also a sub-slot transmission is performed. With regard to the transmission starting in the current time slot i, it is assumed that this transmission extends into the following time slot and no transmission is performed in the first part of the following time slot in the first frequency band 220A, it is not necessary to include a AGC symbol at the beginning of the following time slot so that the symbols extending from the current time slot into the second time slot form a full-slot transmission having a slot structure as described above with reference to FIG. 3A.

In accordance with the above described transmissions extending over two or more slot, also referred to as a slot aggregation, the aggregated slots may be in the same frequency or in a different frequency band, e.g., there may be a certain gap between both frequencies/subchannels/subband/interlaces. In accordance with embodiments, UE 400 may use a first time slot structure and a second time slot structure for a transmission, which, in turn, use the same frequency or a different frequency, with the frequency being defined as one or more of a subchannel, a set of subchannels, a sub-band, a set of sub-bands, an interlace, a set of interlaces, a resource pool, a set of resource pools.

As has been described above, in accordance with embodiments, the basic time slot structure may be as described above with reference to FIGS. 3A and B, wherein an additional starting symbol 224, like an AGC symbol may be used for a UE to start its transmission. In such a case, in accordance with the inventive approach, the additional AGC symbol 226 is provided in a full-slot transmission performed in another frequency band at the same time position/similar position as the second starting position. In accordance with embodiments, the additional or second starting position may be placed inside a time slot at a certain symbol which has a predefined distance from one or more symbols which are used for performing a desired transmission, like providing feedback information or positioning information. Thus, in accordance with embodiments, the additional or second starting symbol may be at a symbol ahead of a single symbol or a symbol block allowing certain transmissions, like
a transmission for which the UE has successfully performed LBT on the subchannel,
a PSFCH transmission, e.g., a standalone PSFCH transmission without data, for transmitting urgent feedback like HARQ-feedback, a transmission of dummy data to retain a Channel Occupancy Time, COT, initiated after performing a listen before talk, LBT, or
a transmission of a predefined reference symbol, e.g., a positioning reference symbols, PRS, used for sidelink positioning, or a reference symbol for a channel reconstruction, like a DRMS, or
a transmission of channel state information, CSI, e.g., a CSI reference symbol, CSI-RS, for improving a Multiple Input Multiple Output, MIMO, channel estimation
a transmission of assistance information message, AIM, or inter-UE coordination messages, IuC,
a transmission comprising of control information, e.g., a MAC-CE which is transmitted within the PSSCH.

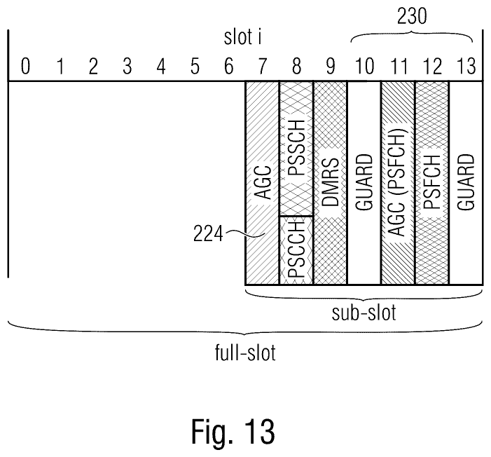

FIG. 13 illustrates an embodiment using the time slot structure according to FIG. 3B with additional AGC symbol 226 located at a position which is three symbols ahead of the PSFCH block 230 including the PSFCH symbols, namely, symbols 10, 11, 12 and 13. Thus, in case the PSFCH is enabled, a sub-slot structure may be defined having the last four symbols dedicated for the feedback transmission, i.e., for sending feedback to the transmitting UE. The symbols include a guard symbol, an AGC symbol for the PSFCH, the actual PSFCH symbol and an additional guard symbol, wherein, dependent on the transmission in the following slot the last symbol 13 may be an optional guard symbol. In accordance with embodiments, the starting symbol 224 is placed at a certain distance from the PSFCH symbol block so as to allow the transmission of dummy data, for example for retaining the COT that was initiated after performing an LBT. This allows the UE to use one or more following time slots also for its transmission. As mentioned above, in accordance with other embodiments, the symbol block 230 may be used for transmitting reference symbols like positioning reference symbols, PRSs, that may be used for sidelink positioning. Also other symbols may be transmitted, for example other reference symbols, symbols for a channel reconstruction like a DMRS symbol or symbols for improving the MIMO channel estimation, like channel state information (CSI) or channel state information reference symbols (CSI-RS) may be transmitted.

Regarding the use of the one or more symbols for performing the certain transmission, like the PSFCH, it is noted that in accordance with embodiments, the symbols for the certain transmission may be configured to be present in every sub-slot structure or only in a subset of the sub-slots, for example the PSFCH may be present with a certain priority, like every second or every fourth sub-slot.

In accordance with embodiments of the present invention, when considering a combination of a sub-slot and a full-slot as shown in the second frequency band 220B of FIG. 13(a), the symbols used for transmitting control data, like the PSCCH, may be reduced thereby increasing the resource efficiency by allowing to transmit more data symbols, like PSSCHs. Thus, in such a case only a single PSSCH following the first AGC symbol of the transmission is used. Thus, according to embodiments, a first PSCCH may be transmitted at the beginning of the current time slot, and/or a second PSCCH may be transmitted at the beginning of the following time slot. When the UE transmits control information only in the first control channel, like a first PSCCH, the control information includes information about the data transmission, including a PSSCH and/or a PSFCH, extending into the following time slot, e.g., by indicating in a SCI the number of time slots for which the data transmission is extended, and whether the following time slots use a full slot structure or a partial slot structure. When the UE transmits control information only in the second control channel, like a second PSCCH, the control information includes information about the data transmission, like a PSSCH, extending into the preceding time slot, e.g., by indicating in a SCI the number of preceding time slots or partial time slots for which the data transmission is extended, and whether the preceding time slots use a full slot structure or a partial slot structure.

In accordance with other embodiments, each of the sub-slot transmission and the full-slot transmission may include a respective PSCCH, as is depicted in the embodiments of FIGS. 12A, B, C and D.

The one or more PSCCHs may include control information pointing to data, like PSSCH, transmitted across the current and following time slots. For example, a first stage SCI may be included in each of the first and second PSCCHs, with the respective first stage SCIs being independent and a first one of the first stage SCIs providing reservation fields pointing to a resource location in subsequent or following time slot. In accordance with other embodiments, the first stage SCIs may be identical, and may include additional fields, like a sub-slot indicator indicating that the sub-slot transmission belongs to a current resource allocation. In accordance with further embodiments, also a second stage SCI may be provided either in one of the PSSCHs, preferably in the one of the full-slot transmission, or in both PSSCHs.

So far, embodiments of a transmitting UE were described, like UE 400 in FIG. 8 transmitting the respective transmissions described in the different frequency bands 220A, 220B. However, further embodiments of the present invention provide a receiving UE, like UE 402 which receives, as is indicated at 428, a transmission from the transmitting UE 400 including the additional AGC symbol 226 at a symbol of a time slot corresponding to a second starting symbol 224. UE 402 performs, as is indicated at 430, a gain control procedure using the additional AGC symbol 226.

In accordance with embodiments, the presence of the additional AGC symbol 226 at the second starting symbol is indicated by a control signaling together with a signaling and/or a configuration of the transmission, e.g., by a SCI field indicating the additional AGC symbol 226, or by a pre-configuration of the PSFCH indicator indicating an absence of the PSFCH. In another embodiment, the SCI includes a field to indicate the one or more AGC symbols allowing a receiver to retune the AGC and puncture the PSSCH accordingly. In a further embodiment, additional AGC symbols are only present if there is no PSFCH in the slot, allowing the reuse of the PSFCH indicator to indicate the presence of additional AGC symbols, meaning that if the PSFCH indicator is set to false, one or more additional AGC symbols are present in the slot.

In yet another embodiment, it is beneficial to allow half-slots only in certain slots of the resource pool. The reasoning for this is that half-slots can cause an increased number of collisions because legacy UEs may not support half-slots and may not read the control information for future reservations which is conveyed there. Hence, they would learn this information only in a following full slot causing erroneous behavior. Furthermore, TRIV and FRIV signal future reservations (time slot and frequency range, e.g., RB set). Then, a UE can use the additional AGC only in slots and RB sets where another UE has reserved a half-slot transmission and otherwise transmit without additional AGC symbol. In another embodiment, half-slots may only be supported in slots that do not contain PSFCH and hence, the additional AGC symbol may only be transmitted in PSFCH-less slots.

The presence of the additional AGC symbol 226 may also be indicated by a resource pool configuration, or by a configuration, or by a pre-configuration. The signaling and/or the configuration or the pre-configuration may be indicated to UE 402 for respective resource pools, i.e., per resource pool, or for respective BWPs, i.e., per BWP, for respective subband or sets of subbands, i.e., per subband or per a set of subbands, e.g., per sub-channel or interlace in an unlicensed spectrum, by a system wide configuration, e.g., using a broadcast message like a System Information Block, SIB and/or a Master Information Block, MIB, or for respective transmissions or sets of transmission, i.e., per transmission, or per a set of transmissions. UE 402 may receive the signaling and/or the configuration from one or more network entities of the wireless communication system, e.g., form one or more of the following:
a base station, like a macro cell base station, or a small cell base station, or a central unit of a base station, or a distributed unit of a base station, or an Integrated Access and Backhaul, IAB, node, a road side unit, RSU,
a UE, like a SL UE, or a group leader UE, GL-UE, or a relay UE,
a remote radio head,
a core network entity, like an Access and Mobility Management Function, AMF, or a Service Management Function, SMF, or a mobile edge computing, MEC, entity, a network slice as in the NR or 5G core context,
any transmission/reception point, TRP, enabling an item or a device to communicate using the wireless communication network, the item or device being provided with network connectivity to communicate using the wireless communication network.

In accordance with other embodiments UE 402 may be provided with the configuration at the time of its manufacture, i.e., it may have a pre-configuration based on a hard-coded configuration. Also, the UE may be preconfigured when being prepared to be used with the wireless communications system, e.g., it may obtain the configuration from a SIM inserted into the UE.

When receiving transmissions from UE 400 in the different channels, a first control channel, like a first PSCCH, may be received by UE 402 at the beginning of the current time slot, and/or a second control channel, like a second PSCCH, may be received at the beginning of the following time slot. When receiving control information only in the first control channel, like a first PSCCH, the control information includes information about the data transmission, including a PSSCH and/or a PSFCH, extending into the following time slot, e.g., by indicating in a SCI the number of time slots for which the data transmission is extended, and whether the following time slots use a full slot structure or a partial slot structure. When receiving control information only in the second control channel, like a second PSCCH, the control information includes information about the data transmission, like a PSSCH, extending into the preceding time slot, e.g., by indicating in a SCI the number of preceding time slots or partial time slots for which the data transmission is extended, and whether the preceding time slots use a full slot structure or a partial slot structure.

### General

Embodiments of the present invention have been described in detail above, and the respective embodiments and aspects may be implemented individually or two or more of the embodiments or aspects may be implemented in combination.

In the above description of embodiments of the present invention reference has been made to a sidelink communication making use of resources in the unlicensed spectrum. It is noted that the present invention is not limited to such embodiments, rather, the inventive approach is equally applicable to systems in which the sidelink communication makes of resources only from the licensed spectrum, and also to embodiments to which the sidelink communication makes use of resources from both the licensed spectrum and from the unlicensed spectrum. Also in such embodiments, when allowing a transmission to start at a second starting symbol during a certain time slot, a transmission in a parallel frequency band using the complete or full timeslot adds an additional AGC symbol at the symbol position corresponding to the second starting symbol.

Further, in the above-described embodiments, it has been assumed that the respective transmissions performed in the different subbands are performed by the same UE, however, it is noted that in accordance with other embodiments, the transmission may also be performed in the same time slot in different frequency bands by different UEs.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

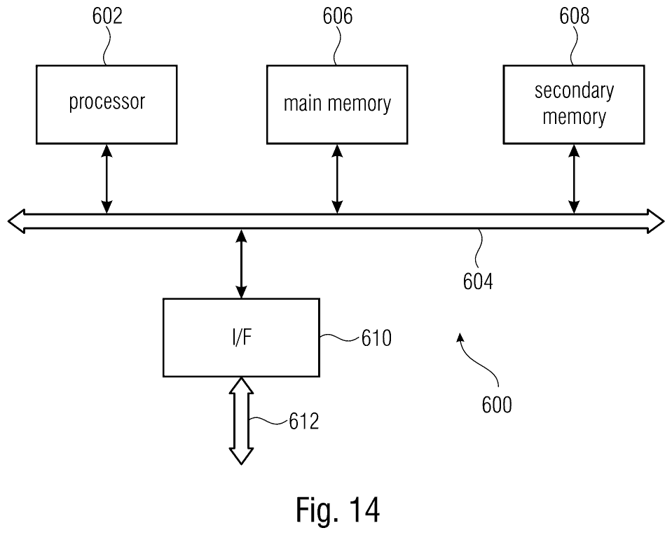

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 14 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above-described embodiments are merely illustrative for the principles of the present invention. It is understood that modifications and variations of the arrangements and the details described herein are apparent to others skilled in the art. It is the intent, therefore, to be limited only by the scope of the impending patent claims and not by the specific details presented by way of description and explanation of the embodiments herein.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication network, like a 3^{rd} Generation Partnership Project, 3GPP, network,
wherein the UE is to communicate with one or more further UEs in the wireless communication network over a sidelink, SL,
wherein the UE is configured or preconfigured with a time slot structure allowing a transmission to be started at one of a plurality of starting symbols during a duration of a time slot, the plurality of starting symbols including a first starting symbol and a second starting symbol, the second starting symbol being offset from the first starting symbol,
wherein the UE is to start a transmission at the first starting symbol or at the second starting symbol, and
wherein, when the UE starts the transmission at the first starting symbol, the UE is to include into the time slot an additional symbol, the additional symbol being ahead of or at a symbol of the time slot corresponding the second starting symbol.

2. The user device of claim 1, wherein the first starting symbol is an automatic gain control, AGC, symbol, and the second starting symbol is an AGC symbol.

3. The user device, UE, of claim 1, wherein the UE is configured or preconfigured with the time slot structure according to one or more of the following:
per resource pool,
per Bandwidth part,
per subband,
per a set of subbands, e.g., per sub-channel or interlace in an unlicensed spectrum,
a system wide configuration, e.g., using a broadcast message like a System Information Block, SIB and/or a Master Information Block, MIB,
per transmission,
per a set of transmissions.

4. The user device, UE, of claim 1, wherein the time slot comprises a plurality of symbols, the first starting symbol is a first symbol in the time slot, thereby allowing a transmission to use a full slot, and the second starting symbol is a second symbol of the time slot or is a symbol offset from the first symbol by one or more symbols, thereby allowing a transmission to use a partial slot.

5. The user device, UE, of claim 1, wherein the UE is configured or preconfigured with a time slot structure and the additional symbol is configured or preconfigured
in every time slot within a SL resource pool, or
only in a proper subset of time slots within the SL resource pool.

6. The user device, UE, of claim 1, wherein
a last symbol of the time slot comprises a guard symbol, and
the UE is to use the guard symbol for a data transmission, e.g., for the transmission of a Physical Sidelink Shared Channel, PSSCH, or a Physical Sidelink Feedback Channel, PSFCH, or a Physical Sidelink Control Channel, PSCCH, or a Demodulation Reference Signal, DMRS,
when the UE starts the transmission at the first starting symbol in a current time slot using the additional symbol or at the second starting symbol in the current time slot, and
when the UE is to also transmit in a following time slot, or, at the end of the current time slot, is to enter a Discontinuous Reception, DRX, mode.

7. The user device, UE, of claim 1, wherein
a first time slot structure is the time slot structure allowing the transmission to be started at one of the plurality of starting symbols, and a second time slot structure is a time slot structure allowing the transmission to be started only at the first symbol of a time slot, and
when the UE starts the transmission at the first starting symbol in a current time slot using the additional symbol and is to perform a transmission in a following time slot, the following time slot comprises the first time slot structure or the second time slot structure, or
when the UE starts the transmission at the second starting symbol in a current time slot and is to perform a transmission in a following time slot, the following time slot comprises
the first time slot structure, or
the second time slot structure, or
a third time slot structure, the third time slot structure allowing a first transmission to be started at a first starting symbol during a duration of the following time slot, and allowing a second transmission to be started at a second starting symbol following the first starting symbol during the duration of the following time slot, or
a fourth time slot structure, the fourth time slot structure allowing the transmission in the current time slot to be extended into the following time slot without an AGC symbol and/or a control symbol at the beginning of the following time slot.

8. The user device, UE, of claim 1, wherein
the time slot structure includes a predefined number of symbols at the end of the time slot which are dedicated for receiving a transmission, such as a feedback transmission, e.g., a first guard symbol, an AGC symbol for the PSFCH, the PSFCH symbol, and a second guard symbol, and
the second starting symbol is offset from a first symbol of the predefined number of symbols, and the UE is to use the one or more symbols between the second starting symbol and the first symbol of the predefined number of symbols for a certain transmission, e.g.,
a transmission of dummy data to retain a Channel Occupancy Time, COT, initiated after performing a Listen Before Talk, LBT, or
a transmission of a predefined reference symbol, e.g., a positioning reference symbols, PRS, used for sidelink positioning, or a reference symbol for a channel reconstruction, like a DRMS, or
a transmission of channel state information, CSI, e.g., a CSI reference symbol, CSI-RS, for improving a Multiple Input Multiple Output, MIMO, channel estimation
a transmission of assistance information message, AIM, or inter-UE coordination messages, IuC,
a transmission comprising of control information, e.g., a MAC-CE which is transmitted within the PSSCH.

9. The user device, UE, of claim 1, wherein
the UE is to use one or more symbols between the second starting symbol and the end of the time slot for a certain transmission, e.g.,
a transmission for which the UE has successfully performed LBT on the subchannel,
a PSFCH transmission, e.g., a standalone PSFCH transmission without data, for transmitting urgent feedback like HARQ-feedback,
a transmission of dummy data to retain a Channel Occupancy Time, COT, initiated after performing a listen before talk, LBT, or
a transmission of a predefined reference symbol, e.g., a positioning reference symbols, PRS, used for sidelink positioning, or a reference symbol for a channel reconstruction, like a DRMS, or
a transmission of channel state information, CSI, e.g., a CSI reference symbol, CSI-RS, for improving a Multiple Input Multiple Output, MIMO, channel estimation
a transmission of assistance information message, AIM, or inter-UE coordination messages, IuC,
a transmission comprising of control information, e.g., a MAC-CE which is transmitted within the PSSCH.

10. The user device, UE, of claim 1, wherein a first control channel, like a first PSCCH, is transmitted at the beginning of the current time slot, and/or a second control channel, like a second PSCCH, is transmitted at the beginning of the following time slot.

11. The user device, UE, of claim 1, wherein the UE is to communicate with the one or more further UEs over the SL using a set of resources in an unlicensed spectrum.

12. The user device, UE, of claim 1, wherein the time slot structure allows to be started at at least one further starting symbol during the duration of the time slot.

13. The user device, UE, of claim 1, wherein the UE is configured with the time slot structure by one or more network entities of the wireless communication system.

14. A user device, UE, for a wireless communication network,
wherein the UE is to communicate with one or more further UEs of the wireless communication network,
wherein the UE is to receive a transmission from a transmitting UE during a time slot, wherein the transmission of the transmitting UE starts at a first starting symbol during a duration of a time slot,
wherein the UE is to transmit a transmission during the time slot, wherein the transmission of the UE starts at a second starting symbol during a duration of a time slot, the second starting symbol being an AGC symbol and being offset from the first starting symbol,
wherein the transmission includes an additional symbol ahead of or at a symbol of the time slot corresponding to the second starting symbol.

15. The UE of claim 14, wherein the presence of an additional symbol ahead of or at the second starting symbol is indicated by one or more of
a control signaling together with a signaling and/or a configuration of the transmission, e.g., a SCI field indicating an additional AGC symbol, or a pre-configuration of the PSFCH indicator indicating an absence of the PSFCH,
a resource pool configuration,
a configuration,
a pre-configuration.

16. The user device, UE, of claim 14, wherein a first control channel, like a first PSCCH, is received at the beginning of the current time slot, and/or a second control channel, like a second PSCCH, is received at the beginning of the following time slot.

17. The user device, UE of claim 16, wherein the UE is to receive control information only in the first control channel, like a first PSCCH, wherein the control information includes information about the data transmission, including a PSSCH and/or a PSFCH, extending into the following time slot, e.g., by indicating in a SCI the number of time slots for which the data transmission is extended, and whether the following time slots use a full slot structure or a partial slot structure.

18. The user device, UE of claim 16, wherein the UE is to receive control information only in the second control channel, like a second PSCCH, wherein the control information includes information about the data transmission, like a PSSCH, extending into the preceding time slot, e.g., by indicating in a SCI the number of preceding time slots or partial time slots for which the data transmission is extended, and whether the preceding time slots use a full slot structure or a partial slot structure.

19. A method for operating a user device, UE, for a wireless communication network, wherein the UE communicates with one or more further UEs in the wireless communication network over a sidelink, SL, the method comprising:
configuring or preconfiguring the UE with a time slot structure allowing a transmission to be started at one of a plurality of starting symbols during a duration of a time slot, the plurality of starting symbols including a first starting symbol and a second starting symbol, the second starting symbol being an AGC symbol and being offset from the first starting symbol,
starting, by the UE, a transmission at the first starting symbol or at the second starting symbol, and
when the UE starts the transmission at the first starting symbol, including, by the UE, into the time slot an additional symbol, the additional symbol being ahead of or at a symbol of the time slot corresponding the second starting symbol.
